(19) United States
(12) Patent Application Publication
(10) Pub. No.: US 2019/0171654 A1
(43) Pub. Date: Jun. 6, 2019

(54) Correlation-based design method, system and device

(71) Applicant: Predictum Inc., Toronto (CA)

(72) Inventors: Wayne J. Levin, Toronto (CA); Farhan Mansoor, Toronto (CA)

(73) Assignee: Predictum Inc., Toronto (CA)

(21) Appl. No.: 15/998,831

(22) Filed: Aug. 16, 2018

Related U.S. Application Data
(60) Provisional application No. 62/546,318, filed on Aug. 16, 2017.

(51) Int. Cl. G06F 16/28; G06F 17/50; G06F 17/15; G06F 16/26

(52) U.S. Cl. CPC G06F 16/288; G06F 17/5009; G06F 16/26; G06F 16/287; G06F 17/153

(57) ABSTRACT

A method, system and device for correlation-based design is described herein. The method, in an embodiment, includes receiving one or more access requests corresponding to a plurality of targeted outcomes of an improved version of a prior production process or prior operation for an offering. In response, the method includes accessing a first pool of historical control factors, accessing a second pool of historical outcome factors, and generating a first graphical correlation representation of the historical control factors, the historical outcome factors, and the targeted outcome factors. The historical control factors of the first pool were previously implemented in the prior production process or prior operation. The historical outcome factors of the second pool resulted from one of the historical control factors. The first graphical correlation representation indicates a first comparison of the historical outcome factors to the targeted outcome factors.

### CROSS-REFERENCE TO RELATED APPLICATION

This application is a non-provisional of, and claims priority to and the benefit of U.S. Provisional Patent Application No. 62/546,318, filed Aug. 16, 2017. The entire contents of such application are hereby incorporated herein by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

Capturing, sharing, and reusing knowledge, such as the ability to accurately and consistently predict outcomes given a specific set of input factors, is a major challenge in science and engineering. Human brains are excellent at developing knowledge, but they are poor containers of knowledge because: (a) of the vagaries associated with memory, (b) knowledge is insufficiently indexed and organized so it cannot be sought, shared and reused, and, (c) as a result, it is largely inaccessible to others and remains isolated in individuals. Organizations pay for the same insights and, usually unknowingly, more than once miss the opportunity to identify and examine inconsistencies across studies (evidence), among subject matter experts (SMEs). In general, SMEs without access to prior knowledge, will unknowingly regenerate prior knowledge at additional expense. In addition to the cost of the re-acquisition of prior knowledge, there is also the cost of delaying a solution to the problem or a desired discovery. Between what SMEs think and what the evidence supports, organizations are much less efficient and effective in developing their products and processes to achieve objectives related to quality, productivity, compliance, and costs.

For example, a chemical engineer may design a product prototype over six months of research and development (R&D) work. During the R&D, the engineer may use various segregated documentation tools and resources, such as spreadsheets, word processing software and physical lab notebooks. Because of a change in focus, the employer-manufacturer may place the project on hold for a year. By the time the project resumes, the engineer may have ended the employment with the manufacturer. One and a half years later, the manufacturer may assign a new chemical engineer to resume the project. Referring to the departed engineer's various notes, documents and files, the new engineer must try to rediscover the learnings, data and insights of the departed engineer. This rediscovery effort (sometimes referred to as reinventing) is inefficient and can result in a waste of valuable human resources and time slowing innovation and the benefits that can be derived from these efforts. Also, this rediscovery process does not reliably or accurately enable the full recovery of prior learnings and information.

The foregoing background describes some, but not necessarily all, of the problems, disadvantages and shortcomings related to the known research, development and design tools and methods.

### SUMMARY

In an embodiment, the method includes receiving one or more access requests corresponding to a plurality of targeted outcomes of an improved version of a prior operation for an offering. The offering includes one of a product and a service. In response to the one or more access requests, the method includes accessing a first pool of historical control factors, accessing a second pool of historical outcome factors, and generating a first graphical correlation representation of the historical control factors, the historical outcome factors, and the targeted outcome factors. Each of the historical control factors has been previously implemented in the prior operation. Each of the historical outcome factors resulted from one of the historical control factors. The first graphical correlation representation indicates a first comparison of the historical outcome factors to the targeted outcome factors. The method also includes receiving a plurality of change requests. Each of the change requests is associated with a different design scenario. In response to each of the change requests, the method includes changing at least one of the historical control factors, and updating at least one of the historical outcome factors. The at least one changed historical control factor and the at least one updated historical outcome factor include one of the different design scenarios. The method includes generating a second graphical correlation representation of a plurality of the design scenarios and the targeted outcome factors. The second graphical correlation representation indicates a second comparison among the updated historical outcome factors of one of the design scenarios, the updated historical outcome factors of another one of the design scenarios, and the targeted outcome factors. The method includes receiving a selection request corresponding to a selection of one of the design scenarios, and designating the selected design scenario for implementation in the improved version of the prior operation.

In an embodiment, the method includes receiving one or more access requests corresponding to a plurality of targeted outcomes of an improved version of a prior operation for an offering. The offering includes one of a product and a service. In response to the one or more access requests, the method includes accessing a first pool of historical control factors, accessing a second pool of historical outcome factors, and generating a first graphical correlation representation of the historical control factors, the historical outcome factors, and the targeted outcome factors. Each of the historical control factors has been previously implemented in the prior operation. Each of the historical outcome factors resulted from one of the historical control factors. The first graphical correlation representation indicates a first comparison of the historical outcome factors to the targeted outcome factors.

In an embodiment, one or more data storage devices include instructions that, when executed by a processor, perform a plurality of steps of a method. The method includes receiving one or more access requests corresponding to a plurality of targeted outcomes of an improved version of a prior operation for an offering. The offering includes one of a product and a service. In response to the one or more access requests, the method includes accessing a first pool of historical control factors, accessing a second pool of historical outcome factors, and generating a first graphical correlation representation of the historical control factors, the historical outcome factors, and the targeted outcome factors. Each of the historical control factors has been previously implemented in the prior operation. Each of the historical outcome factors resulted from one of the historical control factors. The first graphical correlation representation indicates a first comparison of the historical outcome factors to the targeted outcome factors.

An advantage that may be realized in the practice of some disclosed embodiments of the method, system or device is that historical data of different operation implementations may be correlated to determine new input control factors for an enhanced design scenario that will allow the production or operation process to proceed with an enhanced level of measured outcome factors that are critical to the quality of the operation.

Additional features and advantages of the present disclosure are described in, and will be apparent from, the following Brief Description of the Drawings and Detailed Description.

### BRIEF DESCRIPTION OF THE DRAWINGS

FIG. 1 is a schematic, block diagram illustrating an embodiment of a system for implementing a operation.

FIG. 2 is a schematic, block diagram illustrating an embodiment of a system for implementing a correlation-based design method.

FIGS. 3A-3B are flowcharts illustrating an embodiment of a correlation-based design method.

FIGS. 4A-4I are schematic, block diagrams illustrating embodiments of graphical user interfaces, e.g., for depicting graphical correlation representations.

FIGS. 5-25 are schematic, block diagrams illustrating embodiments of graphical user interfaces, e.g., for managing and administrating system for implementing a operation.

### DETAILED DESCRIPTION

The present disclosure relates to, in one aspect, techniques that facilitate generating an optimized or improved version of a prior operation. Examples of an operation include: an operation for producing or performing an offering, such as a product or service; a manufacturing process or procedure for manufacturing an offering, such as a product or service; a production process; logistics; R&D; design; and any other process or technological procedure that includes a number of steps that are performed to produce or cause an outcome. Such an operation may be carried out in factories, manufacturing plants, R&D centers, laboratories, warehouses, shipping depots, airports, and other facilities and applications in which numerous computer-based devices are used to implement the steps required to produce or perform an offering, such as a product or service offering. Advantageously, the techniques disclosed herein make use of enhanced database, correlation-based architectures, and/or machine learning to enable improvements in computing technologies and the application of computing technologies to the field of operation optimization for offering design.

Various challenges in the operation optimization field have been identified in the background above. For instance, a first challenge is in obtaining, holding and exploiting a comprehensive understanding of the factors that impact a process, and learning how those factors may interact with each other and affect the results of the process. These results can include both the immediate responses of a particular step and the across-production-process responses. For example, conventional techniques fail to fully account for the interaction between different factors.

In addition, another challenge is to incorporate and learn from the relationships that are generated across different formal and informal experiments and observations across multiple people over time. Further, information from different experiments may conflict, and those conflicts are not readily resolved, leading to a lack of understanding. For example, conventional techniques are limited to relationships that are present in a single experiment, and fail to correlate information across numerous experiments. These conflicts usually go unnoticed but, if identified and eventually understood, could lead to exploitable insights instead of confusion.

In one example of the disclosed system, the combination of previous observations (e.g., the atomic unit of knowledge), factor information, statistical significance and the prediction models from past experiments are used as prior knowledge which is fed into a method, system or device having, e.g., machine learning systems that perform a correlation-based technique to identify which factors at which levels are most promising in maximizing the results that are critical to quality (CTQ). The outputs of the correlation-based technique may then be fed into an operation, resulting in an improvement to the process for creating the product or service offering.

One advantage of the disclosed system is that if a problem arises that is related to a particular CTQ or a particular step in production, the system can allow a lookup of prior research into that problem, so that the prior research can be considered. Because the disclosed system provides availability and access to prior knowledge generated by others, even if they are not available or no longer with the entity, engineers and scientists may use this historical prior knowledge to compare their thinking (e.g., their theories) against those of others, and against prior collected evidence, or collect new evidence to challenge their thinking, leading to improved efficiency and effectiveness. Such a system can be useful for engineers and scientists who tend to work alone and often start only with their own thinking and experience. This system expands the range of experience and thinking across their peers, past and present and allows them to work collaboratively over time, comparing their experience with those of others and generating new experience (e.g., collecting evidence) where none exists or to verify/validate previously collected evidence and the relationships they support. This expansion provides a fast and comprehensive start and ongoing input into research and problem solving leading to faster and better solutions and discoveries.

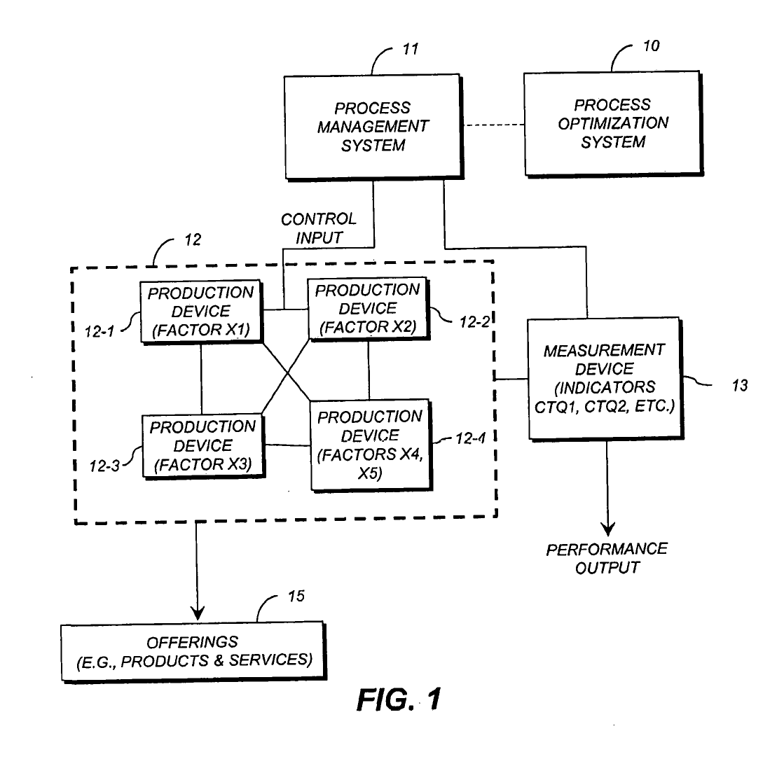

FIG. 1 is a schematic, block diagram illustrating an embodiment of a system for implementing an operation involving a production process associated with a product offering 15. It should be appreciated, however, that the operation can involve a service process associated with a service offering 15. As depicted in the embodiment of FIG. 1, a process optimization system 10 may be coupled to a process management system 11. In one example, the process management system 11 is used to control an operations process that is implemented using various production devices, such as production devices 12-1-12-4, referred to collectively as production devices 12, and the process management system 11 may implement the improved process design generated by the process optimization system 10. During, before, or after operations of the production devices 12, one or more measurement devices 13 may be used to measure performance results or performance outputs of the process. A plurality of key performance indicators (KPI), critical to quality metrics (CTQ) and historical outcomes include or are based on these measured results or outputs of the process. In another embodiment, instead of dedicated measurement devices 13, the product devices 12 can perform any needed measurements.

By way of explanation, during a run of an operation or production process, each of the production devices 12 may be controlled by one or more control factors, such as control factors X1-X5. In the embodiment of FIG. 1, production device 12-1 has control factor X1, production device 12-2 has control factor X2, production device 12-3 has control factor X3, and production device 12-4 has control factors X4, X5. Conceptually, these control factors are analogous to knobs that can control the inputs to the production process, and a goal of the disclosed system is to determine the settings that lead to improvements of the process. These inputs could be process parameters such as pressure, temperature, volume, concentration, recipe (e.g., chemical components), size, destination, weight, etc.

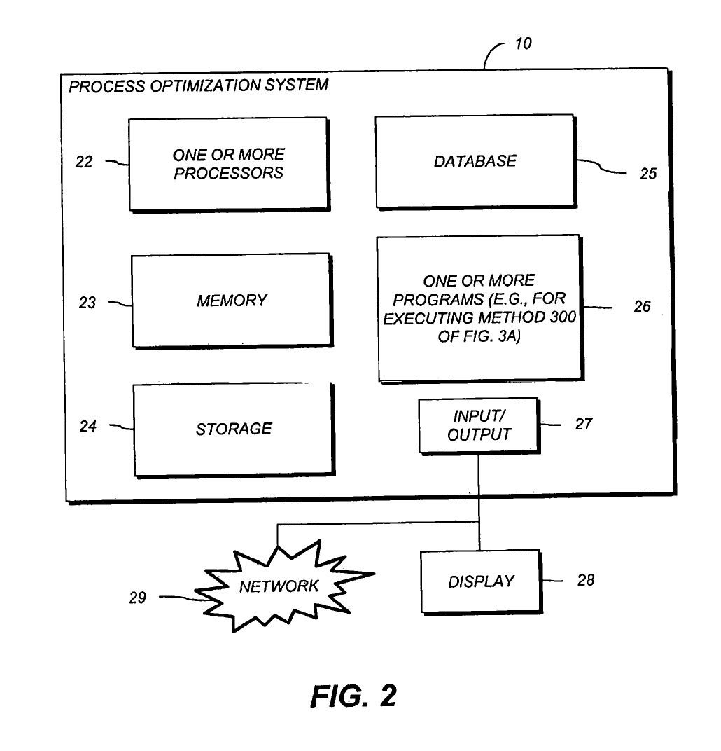

The process optimization system 10, described in further detail below with respect to FIG. 2, may be indirectly or directly connected to the process management system 11. An example of an indirect connection is that output of the process optimization system 10 is entered by into the process management system 11 on an ad hoc basis. An example of a direct connection is that output of the process optimization system 10 and input therefrom automatically flow between the systems over a computer network, advantageously facilitating, for example, machine learning or artificial intelligence operations of the production process using the techniques set forth herein.

FIG. 2 is a schematic, block diagram illustrating an embodiment of the process optimization system 10 for implementing a correlation-based design method. In the embodiment of FIG. 2, the process optimization system may include one or more processors 22, a memory 23, a storage 24, a database 25, one or more programs 26, an input/output 27, and a display 28. The process optimization system may communicate using a network 29. The process optimization system 10 may include one or more co-located or distributed computing systems having the one or more processors 22, such as computer servers, which may be locally hosted or hosted on a cloud computing platform. The memory 23 and storage 24 may be shared and/or local. The memory 23 may include random access memory for running software programs to implement the methods set forth herein. The storage 24 may be used to store executable programs having instructions for implementing the methods set forth herein. The database 25 may be a relational database, and may be accessible by all the one or more processors 22, and may be used to store pools of historical information derived from the production processes described above with respect to FIG. 1.

The one or more programs 26 may execute on some or all of the one or more processors 22, and may have access to the memory 23, storage 24, database 25, input/output 27, display 28 and network 29. For example, the one or more programs 26 may facilitate the process optimization system 10 communicating with the process operations system 11 (FIG. 1).

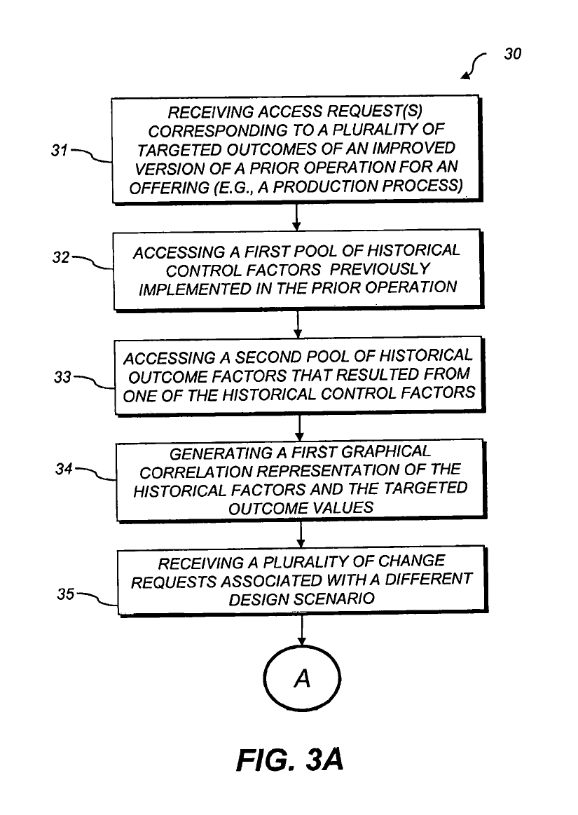

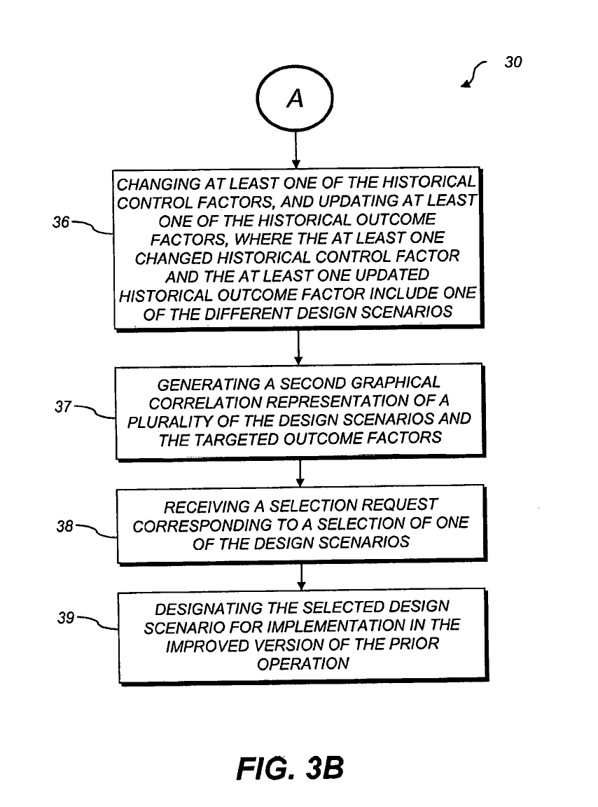

FIGS. 3A-3B are flowcharts illustrating an embodiment of a correlation-based design method 30, e.g., for improving the results of a process. In one embodiment, the method 30 is executed by the one or more programs 26 of the process optimization system 10 (FIG. 2).

As depicted in the embodiment of FIG. 3A, the method 30 at block 31 receives one or more access requests corresponding to a plurality of targeted outcomes of an improved version of a prior operation or prior production process for an offering. In such a case, the offering may include a product offering, a service offering, or some combination thereof.

In an embodiment, in response to the one or more access requests, the method 30 at block 32 accesses a first pool of historical control factors. For example, the one or more programs 26 (FIG. 2) executing the method 30 at block 32 may access the first pool of historical control factors from the database 25 or the storage 24 (FIG. 2). In one embodiment, each of the historical control factors has been previously implemented in the prior production process managed by process management system 11 (FIG. 1), and may include, for example, the control factors X1-X5 related to the production devices 12-1-12-4 (FIG. 1). Advantageously, the historical control factors are used to index the various formal and informal experiments, and may be correlated by comparing the different control factors used in each experiment and determining which control factors are common across each of the experiments. For example, a first historical experiment could include historical data such as temperature and pressure of a specific production device 12, and a second historical experiment could include historical data such as temperature and recipe that the specific production device 12 was operated at. In such a case, a comparison of the two experiments would reveal that a common control factor of temperature applied to both of these experiments, allowing the method to directly correlate and compare these experiments. In one example, an analysis of the production process may be performed in order to determine what control factors are most relevant, e.g., to the goal of yielding improved outcome factors. In another example, a plurality of control factors may be simply collected, and analyzed later to determine which are most relevant to yield an improvement to the process.

Continuing, in one embodiment, the method 30 at block 33 accesses a second pool of historical outcome factors. Similar to the first pool, the one or more programs 26 (FIG. 2) executing the method 30 at block 33 may access the second pool from the database 25 or the storage 24 (FIG. 2). In one embodiment, each of the historical outcome factors resulted from one of the historical control factors, e.g., an implementation of the prior operation or prior production managed by process management system 11 (FIG. 1) and using the control factors X1-X5 related to the production devices 12-1-12-4 (FIG. 1), may be measured by the measurement device 13 (FIG. 1) to have historical outcome factors such as CTQ1 and/or CTQ2. One advantage of separating the control factors from the outcome factors is that different experiments can be compared and correlated by reference to common control and outcome factors, so that experiments with improvements in control factors can be determined.

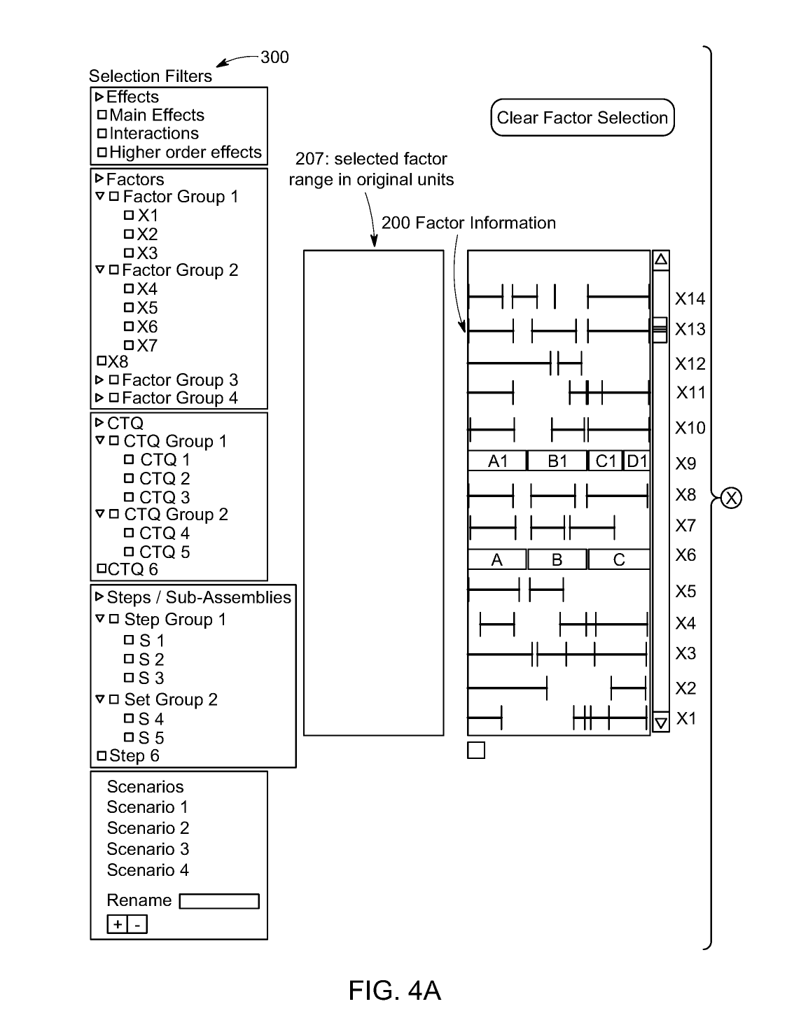

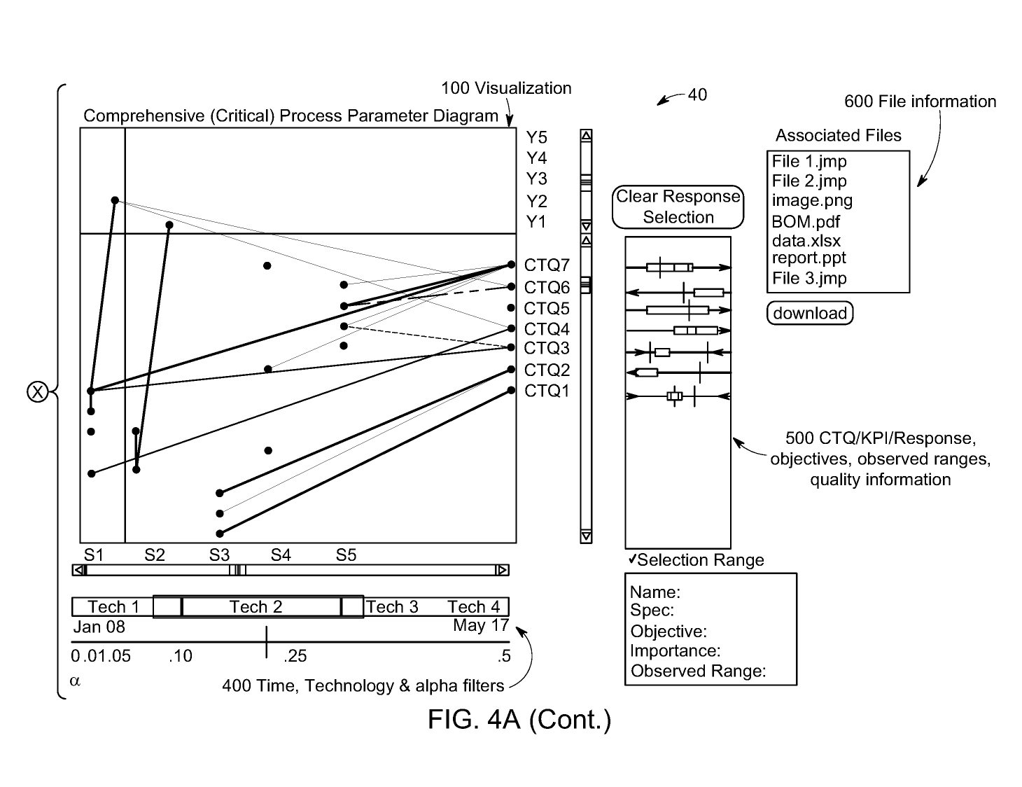

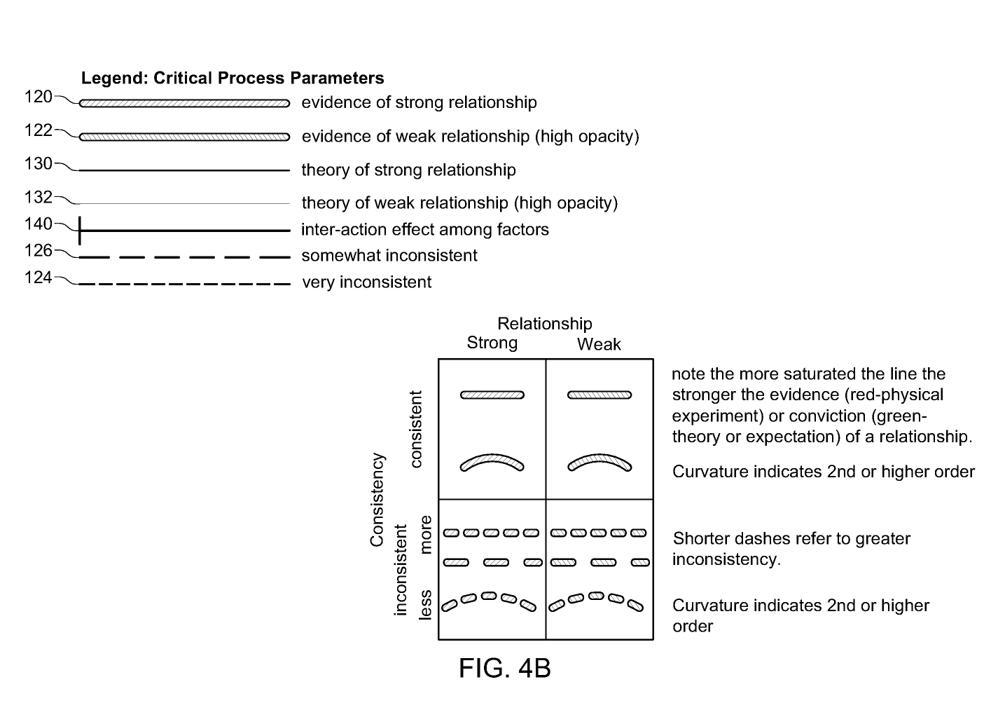

In the embodiment of FIG. 3A, the method 30 at block 34 may generate a first graphical correlation representation of the historical control factors, the historical outcome factors, and the targeted outcome factors. For instance, the first graphical correlation representation may be displayed in a graphical user interface 40 (see FIG. 4A). Advantageously, the first graphical correlation representation indicates a first comparison of the historical outcome factors to the targeted outcome factors. For example, the impact that a particular control factor has on a particular outcome factor is graphically correlated and displayed so that the system benefits from knowledge of the prior runs of an operation or production process, e.g., by displaying which control factors should be changed to gain the most improvements in the outcome factors.

Further, the method 30 at block 35 may receive a plurality of change requests. For instance, a change request for outcome factors 500A (FIG. 4G) or a change request for outcome factors 500B (FIG. 4H) may be received. Each of the change requests may be associated with a different design scenario that is considered in order to optimize the production process. In operation, the system may receive many change requests, such as hundreds or thousands of change requests, allowing the system to evaluate the results of each such request to succeed at finding a scenario with superior results.

Continuing with the embodiment of FIG. 3B, in response to each of the change requests, the method 30 at block 36 may change at least one of the historical control factors, and update at least one of the historical outcome factors. For example, such changes and updates are depicted in FIGS. 4G-4H. The at least one changed historical control factor and the at least one updated historical outcome factor may include one of the different design scenarios. One benefit of correlating changes in control factors to updated outcome factors is that the different design scenarios can be evaluated against each other, e.g., to determine which offers the most improvement over a plan of record.

Next, the method 30 at block 37 may generate a second graphical correlation representation of a plurality of the design scenarios and the targeted outcome factors. For instance, the second graphical correlation representation may be displayed in a graphical user interface 41 (see FIG. 4E). The second graphical correlation representation can indicate a second comparison among the updated historical outcome factors of one of the design scenarios, the updated historical outcome factors of another one of the design scenarios, and the targeted outcome factors. The second graphical correlation representation advantageously builds upon the historical data to produce and visualize new design scenarios that can have different outcomes than any of the historical scenarios. For example, when a new combination of control factors is selected that is different than any historical data, such a scenario can be evaluated to predictively determine if the outcomes are at or near a target outcome. A machine learning technique, such as iteratively trying numerous combinations of previous control factors and then narrowing in on combinations that show improved outcomes may be employed to determine ideal control factors to reach a target.

Continuing with the embodiment of FIG. 3B, the method 30 at block 38 may receive a selection request corresponding to a selection of one of the design scenarios. Then, the method 30 at block 39 may designate the selected design scenario for implementation in the improved version of the prior production process. For example, the scenario may be selected for implementation by process management system 11 (FIG. 1) using the control factors that are part of the selected scenario by inputting those control factors into the production devices 12-1-12-4 (FIG. 1), in order to achieve the targeted outcome factors. In such a case, whether or not the targeted outcome factors are achieved may be measured by the measurement device 13 (FIG. 1). Advantageously, after implementation of the production process, all data from the implemented production run is then added to the pool of historical data, allowing the historical pool to grow. In one usage model, dozens or hundreds of small experiments can be performed iteratively using the foregoing method 30. As each production run completes, the next iteration of the method 30 will have access to an increased pool of historical data that can then be used yield an improved set of control factors for the next run.

In another example, the method 30 could be performed across a series of production domains controlled by different entities. For example, numerous entities may own a set of production devices that perform similar tasks, such as, for example, the production of pharmaceutical products, such as tablets and capsules, or the fabrication of semiconductor devices. Each of these example processes include numerous production devices, and learnings from one entity can be captured into a historical pool that is shared with the other entities. In such a way, global knowledge of the performance of the production machines and how that relates to the interplay between various control factors leading to outcome factors can be maintained to the benefit of all entities. In one example, data analytics techniques, such as big data analytics, machine learning, artificial intelligence, and the like, may be employed to determine correlations between the historical pools of data to yield graphical correlation representations, e.g., to zero in on the factors that can be tuned to best improve the process.

FIGS. 4A-4J are schematic, block diagrams illustrating embodiments of graphical user interfaces, e.g., for depicting graphical correlation representations.

FIG. 4A depicts a graphical user interface 40 for depicting graphical correlation representations. As depicted in FIG. 4A, the graphical user interface 40 includes a visualization element 100, control factor element 200, selection filter element 300, data filter element 400, outcome factor element 500, and file element 600. Given a historical pool of data, the filter elements allow for only a subset of the data to be used in a given run of the method 30. For example, the data may be filtered by the date the experiment was run, the production process type, etc., allowing an easy way to start broadly and then narrow in on more likely correlations that could yield insights into how to achieve a superior and improved production process. In another embodiment, manual filters are replaced with automatic filtering that automatically presents the results of the correlation-based method 30 for different models based on different automatically set filtering levels.

FIG. 4B depicts an exemplary legend to succinctly illustrate the potential use of different lines in a correlation visualization, e.g., the correlation visualization element 100 (FIG. 4A). The following line types are depicted in FIG. 4B:

A strong relationship line 120.

A weak relationship line 122.

A very inconsistent line 124.

A somewhat inconsistent line 126.

A strong theory line 130.

A weak theory line 132.

An interaction line 140.

FIG. 4C depicts an enlarged view of the graphical user interface 40 of FIG. 4A. As depicted in FIG. 4C, historical control factors X1-X14 are displayed in the control factor element 200, and historical outcome factors CTQ1-CTQ7 and Y1-Y5 are displayed in the outcome factor element 500. The outcome factors CTQ1-CTQ7 are final process outcome factors, and the outcome factors Y1-Y6 are intermediate outcome factors, outcomes for particular steps within the process. The visualization element 100 has at the bottom a step indicator element 105, which indicates which step each factor is related to. In the embodiment of FIG. 4A, on the left hand side, a selection filter allows selection of steps S1-S5. In another embodiment, the step labels may be highlighted responsive to a mouse hovering over any region of visualization element 100 related to that step.

The visualization element 100 depicts a series of dots 110 and lines (e.g., lines 120, 122, 124, 126, 130, 132, 140 as described in the legend of FIG. 4B) that extend from the dots. The dots 110 indicate which of the control factors X1-X7 displayed in the control factor element 200 has significance at each of the steps S1-S5. Specifically, vertical positions of the dots 110 aligns with the labels in the control factor element 200 to indicate the control factor, e.g., control factors X1-X7, and the horizontal position of the dots 110 aligns with the step indicator element 105 to indicate the step, e.g., steps S1-S5.

The lines (e.g., line 120) of the visualization element 100 indicate a relationship between the control factors X1-X14 and the outcome factors CTQ1-CTQ7 and indirect outcome factors Y1-Y6. A line (e.g., line 120) extending from a specific dot 110 corresponding to a specific control factor to another specific dot 110 that is aligned with a specific indirect outcome factor (either at the same or at a different step, because there may be interactions across steps) indicates that the specific control factor has been found to historically impact the specific indirect outcome factor at that step. In turn, a line (e.g., line 120) may extend from the other specific dot corresponding to the specific indirect outcome factor to a direct outcome factor, indicating a relationship between the indirect and direct outcome factor, e.g., indicating which factors to focus on to achieve improvements in a process.

In a similar manner, a line (e.g., line 120) extending from a specific dot 110 corresponding to a specific control factor to a specific direct outcome factor indicates a relationship between those factors at that step.

For example, the visualization element 100 of FIG. 4C indicates that at step S1: there is a theory of a strong relationship between control factor X4 and outcome factor CTQ4; there is no known relationships regarding control factor X6, which is relevant at step S1; there is a strong relationship between control factor X7 and outcome factor Y2; there is a strong relationship between control factor X8 and outcome factor CTQ7; and there is a theory of a strong relationship between control factor X8 and outcome factor CTQ3.

In addition, the visualization element 100 of FIG. 4C indicates that at step S2: there is a strong interaction relationship involving factors X4 and X6 affecting outcome factor Y1.

Next, the visualization element 100 of FIG. 4C indicates that at step S3: there is a strong relationship between control factor X1 and outcome factor CTQ1; there is a weak relationship between control factor X2 and outcome factor CTQ2; and there is a strong relationship between control factor X3 and outcome factor CTQ2.

Next, the visualization element 100 of FIG. 4C indicates that at step S4: there is no known relationships regarding control factor X5, which is relevant at step S3; there is a weak relationship between control factor X9 and outcome factor CTQ7; and there is no known relationships regarding control factor X14, which is relevant at step S3, and there are no theories relating X5, X9 or X14 with any of the outcome factors.

And finally, the visualization element 100 of FIG. 4C indicates that at step S5: there is no known relationships regarding control factor X10, which is relevant at step S5; there is a weak relationship between control factor X11 and outcome factor CTQ7; there is an inconsistent theorized relation, meaning that different SMEs hold different theories of this relation, between control factor X11 and outcome factor CTQ3; there is a strong relationship between control factor X12 and outcome factor CTQ7; there is a somewhat inconsistent (note the less dashed line 126 as described in the legend of FIG. 4B) theorized relationship between control factor X12 and outcome factor CTQ6; and there is a weak relationship between control factor X13 and outcome factor CTQ7.

The visualization element 100 will display different relationships of the historical pools of data based on how the filtering selections are set. Although FIG. 4C focuses on a graphical view, the same underlying data techniques can be used to automatically cycle through different subsets of the pools of historical data to reveal different patterns and combinations of the factors.

FIG. 4D depicts an enlarged view of the control factor element 200. The control factors X1-X5, X7-X8 and X10-X14 are indicated by a continuous factor indicator 206, that may take on values in a continues range, e.g., between 5 and 50. These continuous factor indicator 206 include normalized factor range indicators 201, which show a horizontal range bounded by vertical lines, within the range from left to right of the control factor element 200. In such a case, each of the factors may be normalized to fit in a normalized range indicator 204, e.g., range of 0-100%. In another case, rather than a range, a fixed level factor indicator 205 indicates that a factor has a fixed value, graphically positioned in a normalized range across the ranges of all input factors depicted in the illustration. On the other hand, control factors X6 and X9 are categorical factor indicators 202 with width proportional to the number of occurrences. Categorical factor indicators 202 are used when a factor can have one of a few values, rather than a continuous range. In one example, a factor group indicator 203 may be clicked to highlight and select related groups. In a further example, the historical data loaded may be filtered to only show the process of record (PoR) by using the PoR range selector 208.

FIG. 4E depicts a graphical user interface 41, after a specific range R1 of control factor X13 has been selected on the graphical user interface 40 of FIG. 4C. In such a case, historical data that does not include production processes in which control factor X13 is in range R1 is excluded, and all remaining data is correlated for display. Ranges of other factors that are not associated with the same operations represented by R1 are grey, rather than black. Those that correspond to the operations selected by R1 are highlighted in black. A range indicator element 207 then depicts the ranges in the (low, high) format to the left of the control factor element 200A. For instance, range R1 corresponds to control factor X13 have a value between 10 and 20, in whatever units are applicable to that control factor.

Notably, visualization element 100A depicts only those relationships that include the control factor X13 within range R1. The relationships depicted are as follows: at step S1 there is a strong relationship between control factor X8 and outcome factor CTQ7; at step S1 there is a theory of a strong relationship between control factor X8 and outcome factor CTQ3; at step S5 there is a weak relationship between control factor X11 and outcome factor CTQ7; at step S5 there is an inconsistent theorized relation between control factor X11 and outcome factor CTQ3; and at step S5 there is a weak relationship between control factor X13 and outcome factor CTQ7. In one example, a user clicking on the range R1 will cause the method 30 to select the relevant pools of historical data that include control factor X13 in range R1, correlated the data, and display the correlated data. In one example, all the matching historical data that has control factor X13 in range R1 will be displayed in the visualization element 100A. One further enhancement of the present technique is that in addition to displaying all the matching data, the matching data can be correlated through the use of averaging or statistical analysis and the averages can be displayed. Advantageously, the method 30 can define a metric that focuses on critical outcome factors, and a weighted average of the matching historical data can be performed using this metric, to reveal another correlated view of the impact of various control factors to outcome factors, and this view can be displayed.

FIG. 4F depicts the outcome factor element 500 of FIG. 4C. In the embodiment of FIG. 4F, the historical outcome factor CTQ7 is a factor that requires a value higher than a certain value as indicated by the medium weight right pointing arrow. The certain value that must be achieved is indicated by a specification limit indicator 501. Next, the historical outcome factor CTQ6 is a factor that requires a value lower than a certain value as indicated by the medium weight left pointing arrow. Further, the historical outcome factor CTQ5 is a very important factor that requires a value higher than a certain value as indicated by the heavy weight right pointing arrow. In addition, the historical outcome factor CTQ4 is a less important factor that requires a value higher than a certain value as indicated by the light weight right pointing arrow. Next, the historical outcome factor CTQ3 is a factor that require a response within a range, as indicated by the inward pointing pair of outer arrows and the two specification limit indicators. Next, the historical outcome factor CTQ2 is a factor that requires a value lower than a certain value as indicated by the medium weight left pointing arrow. And, finally, the historical outcome factor CTQ1 is a factor that requires a response within a range, as indicated by the inward pointing pair of outer arrows and the two specification limit indicators, but is less important, as indicated by the light weight lines and arrows.

FIG. 4G depicts the selection of targeted outcome factors in the output factor element 500A of graphical user interface 41 (FIG. 4E). As depicted in FIG. 4G, a user may draft the left or right side of dark rectangles in the output factor element 500A for each of the outcome factors, to select the desired targets. Upon selection of the desired targets, the required input factors will be correlated as depicted in FIG. 4E using the method 30 of FIG. 3A. Upon the selection of the target ranges, the method 30 performs a correlation of the historical data to find the matching historical data that is within the targeted outcome ranges. This data is then correlated. In one example, a user selecting a range will cause the method 30 to select the relevant pools of historical data that include those outcome ranges, correlate the data, and display the correlated data. In another example, all the matching historical data that has the desired target outcome will be displayed in the visualization element 100A. The matching data can then be correlated through the use of averaging or statistical analysis and the averages can be displayed. Advantageously, the method 30 can define a metric that focuses on critical control factors, and a weighted average of the matching historical data can be performed using this metric, to reveal another correlated view of the impact of various outcome factors to control factors, and this view can be displayed.

FIG. 4H illustrates another selection of targeted outcome factors in an output factor element 500B. Upon such a selection, a different set of required input factors will be determined by the method 30 of FIG. 3A. For example, the targeted outcome factors may be selected based on quality control metrics, to target an improvement in yield, quality, strength, performance, or any other such metric.

FIG. 4I illustrates a graphical user interface 42 for correlating from a historical outcome control factor CTQ7 to show the factors and steps that have backwards dependencies to that control factor. In this example, the historical pool of data is filtered to only include data that has results that measure CTQ7, and all other results are not displayed. The resulting matching data can then be further correlated as described above. In one example, all the matching historical data that has CTQ7 will be displayed in the visualization element 100A. The matching data can then be correlated through the use of averaging or statistical analysis and the averages can be displayed. Advantageously, the method 30 can define a metric that focuses on critical control factors, and a weighted average of the matching historical data can be performed using this metric, to reveal another correlated view of the impact on CTQ7 of various control factors, and this vicw can be displayed.

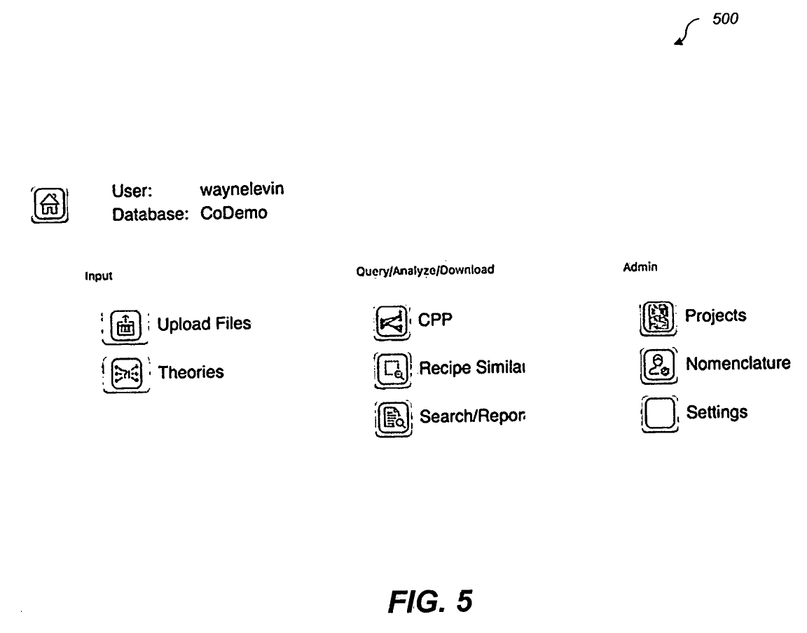

FIG. 5-25 are schematic, block diagrams illustrating embodiments of graphical user interfaces, e.g., for managing and administrating system for implementing an operation. These embodiments may be used to manage the pools of historical data, and manage the results of various experiments, in order to present a set of improved design scenarios that can be implemented or stored for future use.

FIG. 5 depicts a graphical user interface 500 of a home screen. The home button is found throughout the application and returns the user to this screen. Inputs are in the form of data and other sorts of files, as well as theories, where users generate a visual representation of expected relationships. This information is saved in The system's database (currently supported on the Microsoft SQL Server platform). Various reports can be found via the CPP and Search/Reporting (under Query/Analyze/Download) functions which can be navigated to from the home GUI. The Recipe Similarity function, which is discussed below, is also available. Various administration functions are under the Admin tab. Files can be organized by projects. Managing nomenclature (which is described below) is accessible from this screen, as well as various other settings.

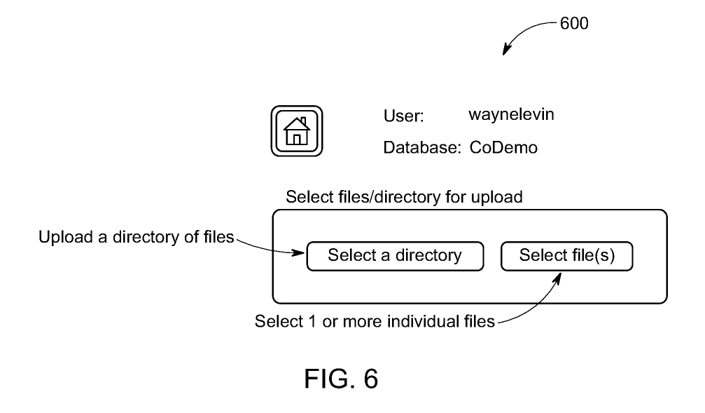

FIG. 6 depicts a graphical user interface 600 for uploading files. Users can choose to upload individual files or an entire directory (folder) of files. Here we demonstrate loading individual files.

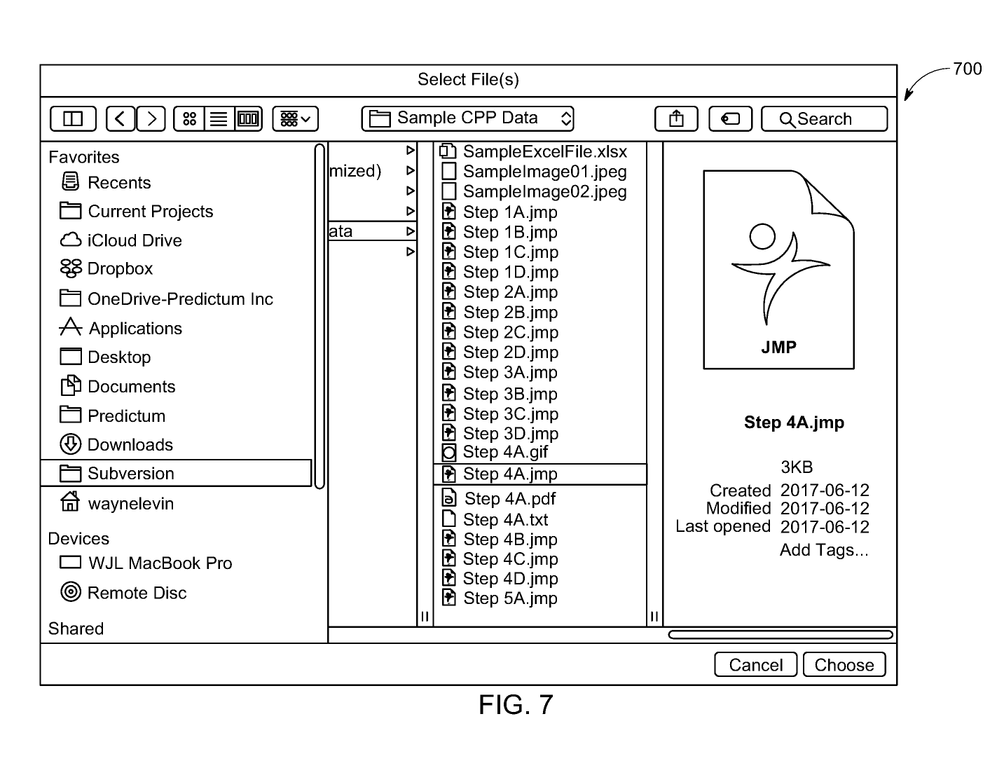

FIG. 7 depicts a graphical user interface 700. In Windows Explorer or the Macintosh Finder, select the file(s) to be uploaded and choose “Choose.” Any file (XLSX, PNG, PDF, JPG, etc.) can be uploaded but, in an embodiment, it is easiest to accompany non-JMP files with JMP files that have the parameter (factor, response) details. JMP® is a suite of computer programs for statistical analysis that is commercially available through SAS Institute. In an embodiment, the one or more programs 26 (FIG. 2) include or are programmed to interface with part or all of the code, logic, configuration, methodologies, specifications, data structures or other features of such JMP® suite of computer programs, all of which are hereby incorporated herein by reference. Any other suitable analytical software program package may be used to implement these statistical features, including, but not limited to Minitab or Tableau.

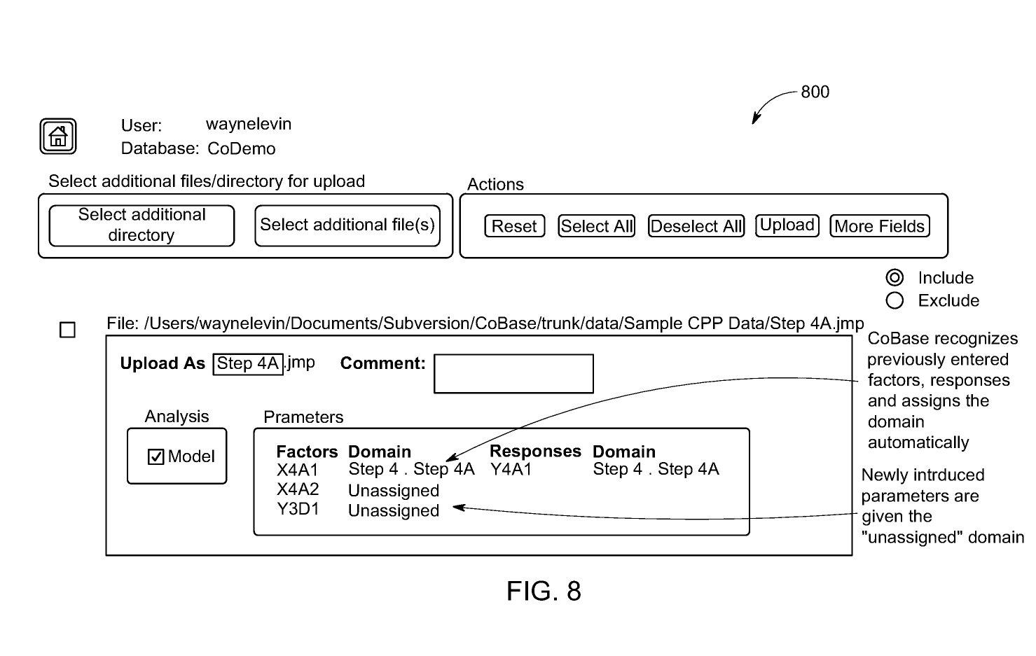

FIG. 8 depicts a graphical user interface 800. The system looks at the files to be loaded and compares the associated factor and response names to the current set in its database. Parameters known to The system will automatically be assigned a domain.

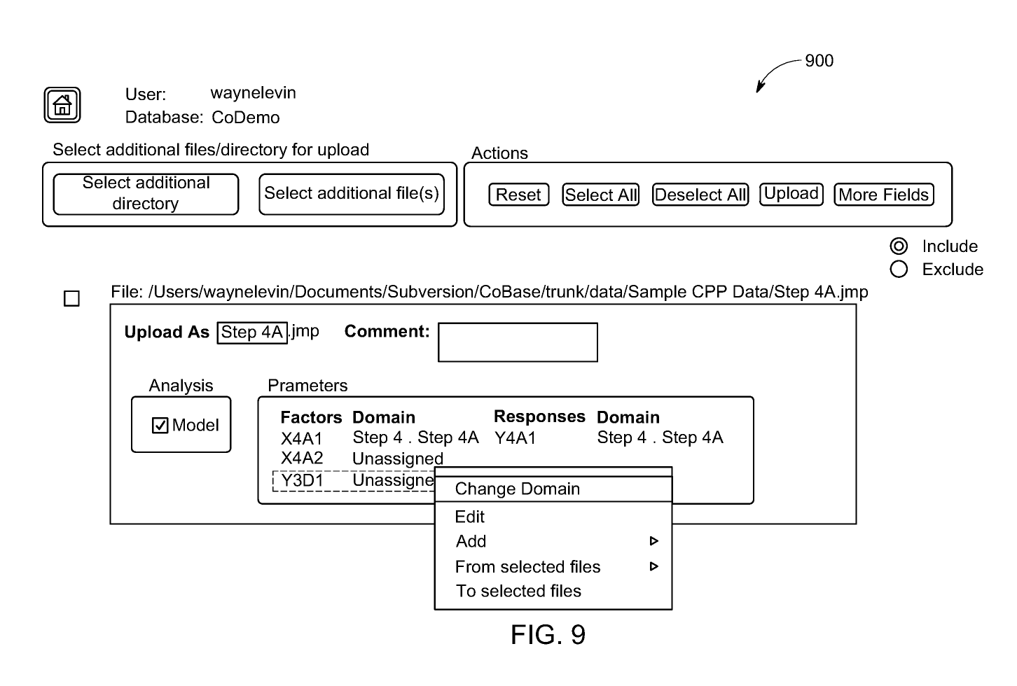

FIG. 9 depicts a graphical user interface 900. Right-click on the unassigned parameters to “Change Domain.” In an embodiment, domain refers to a process Step (such as S1, S2, etc.). In another embodiment, e.g., in the case of a product, domain refers to a particular sub-assembly of components (e.g., in an ink jet printer, a sub-assembly for the paper transport, a sub-assembly for the ink dispensing, a sub-assembly for power management). Sub-assemblies may be made up of component sub-assemblies and individual components.

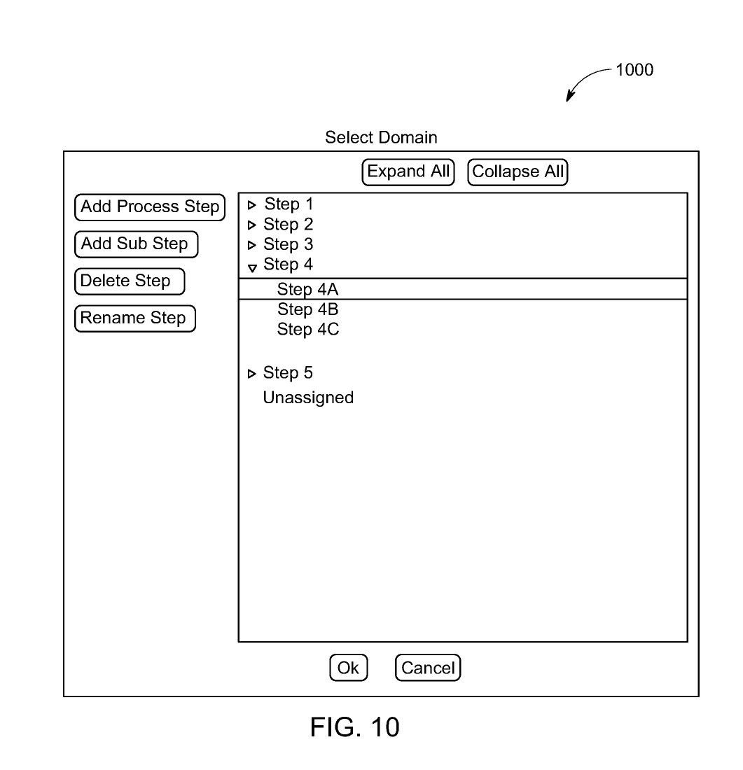

FIG. 10 depicts a graphical user interface 1000. A dialogue (appears and the domain (a production step or a product sub-assembly) can be chosen. Click “OK.”

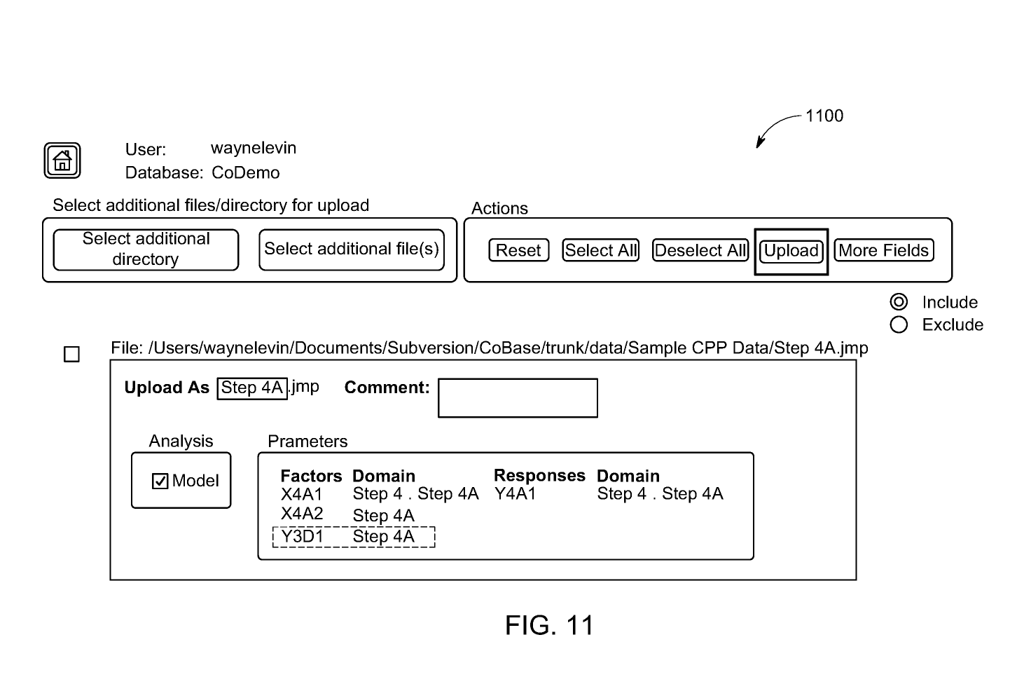

FIG. 11 depicts a graphical user interface 1100. Once assigned the Parameter information is updated. Then simply click “Upload” to upload the information to The system's database.

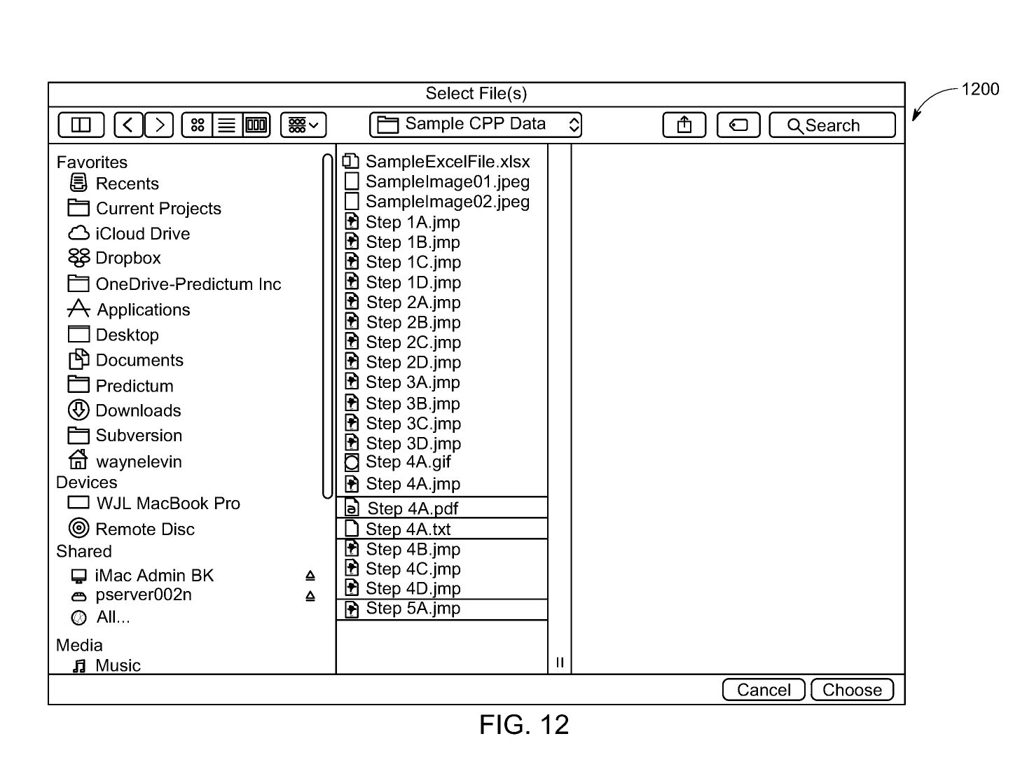

FIG. 12 depicts a graphical user interface 1200. Here various files are being uploaded including non-JMP files.

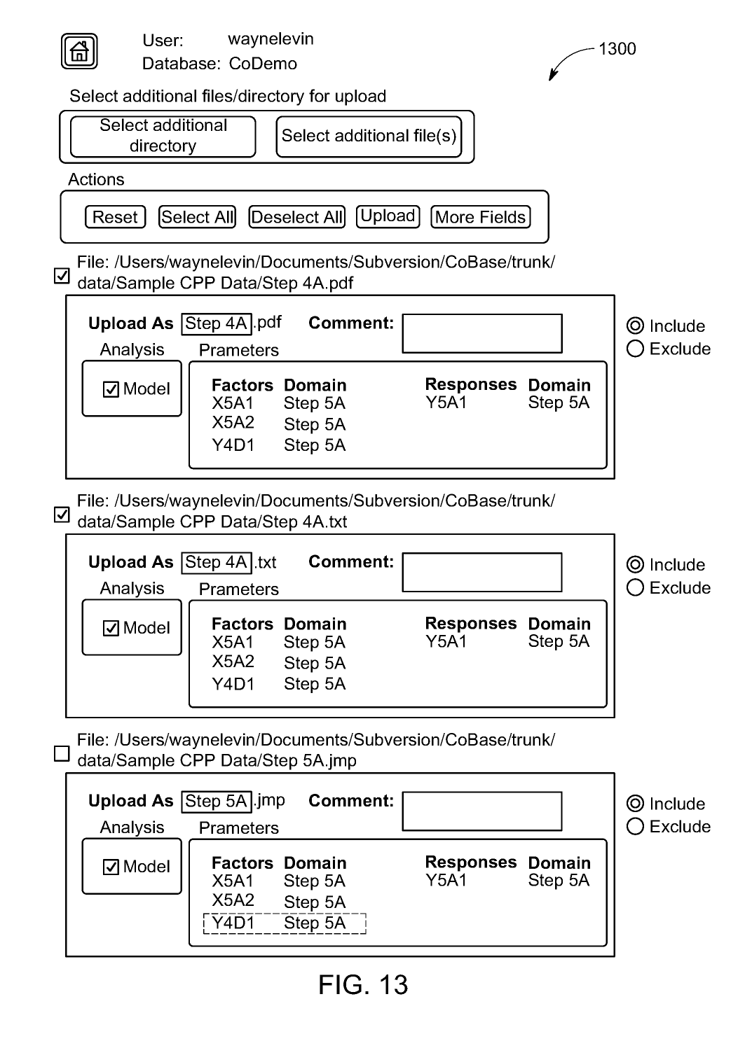

FIG. 13 depicts a graphical user interface 1300. Select the parameters in the JMP file and copy them to the checked-off non-JMP files (instead of entering the parameters for non-JMP files manually).

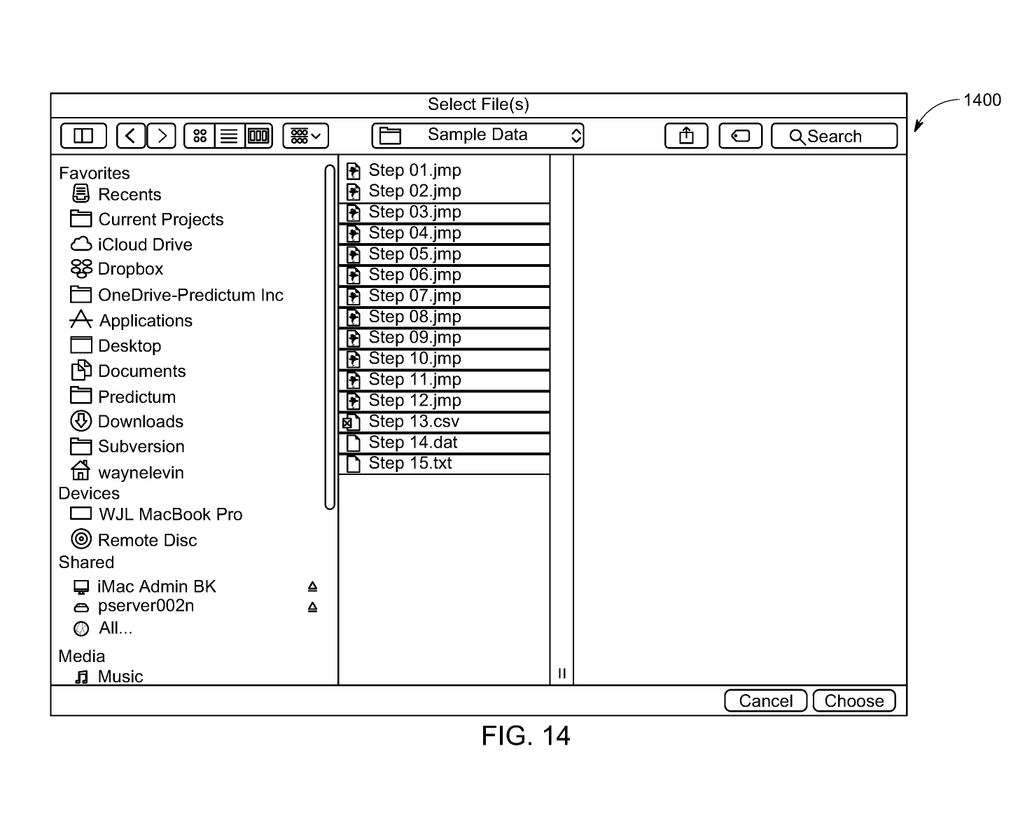

FIG. 14 depicts a graphical user interface 1400, which shows a group of files are selected to be uploaded en masse.

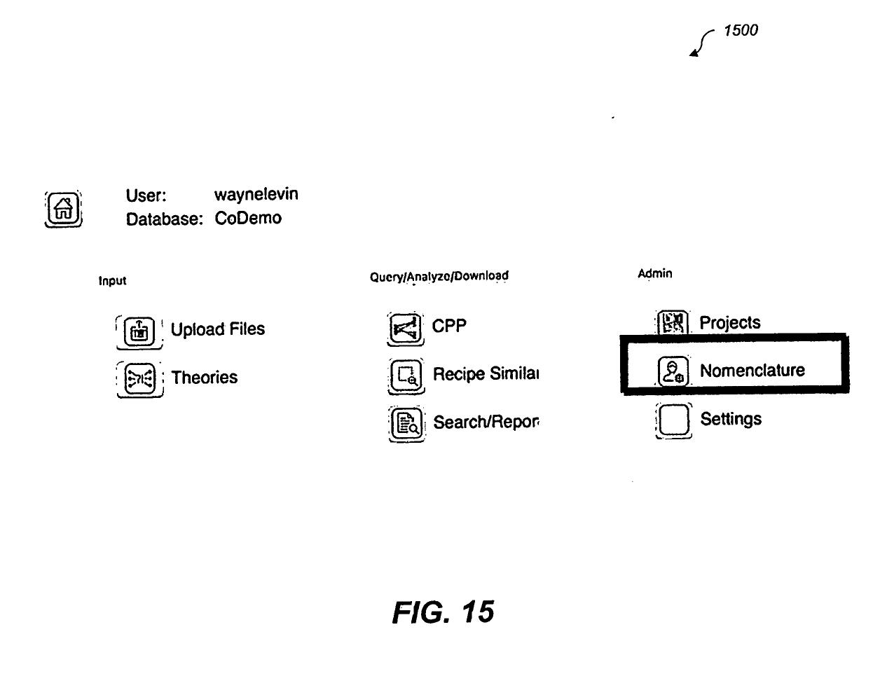

FIG. 15 depicts a graphical user interface 1500. This function will allow analysts to enter a factor combination and get a list of observations, with CTQ values and other information. With data submitted from various individuals, it is fair to assume that there will be inconsistencies in naming parameters as shown in FIG. 15.

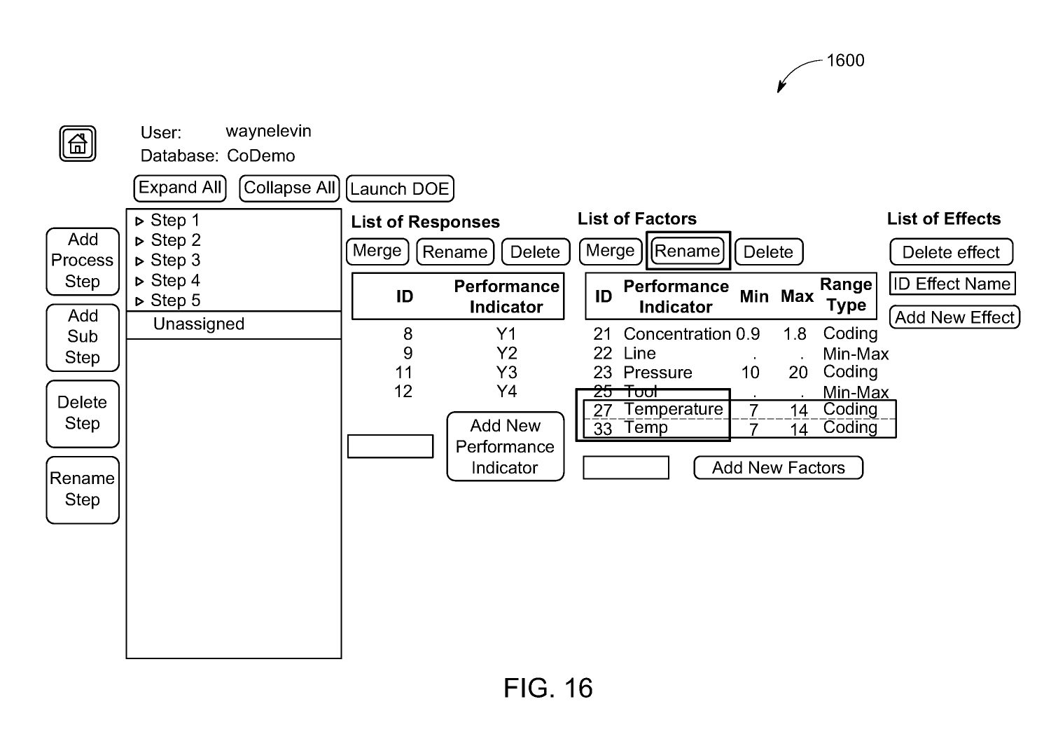

FIG. 16 depicts a graphical user interface 1600, in which two factors that were uploaded from separate files with different names; one Temperature the other Temp. Imported data from different people over time is bound to have varying nomenclature. This needs to be fixed. To do so, select the factor names of interest (Temperature and Temp) then click Rename.

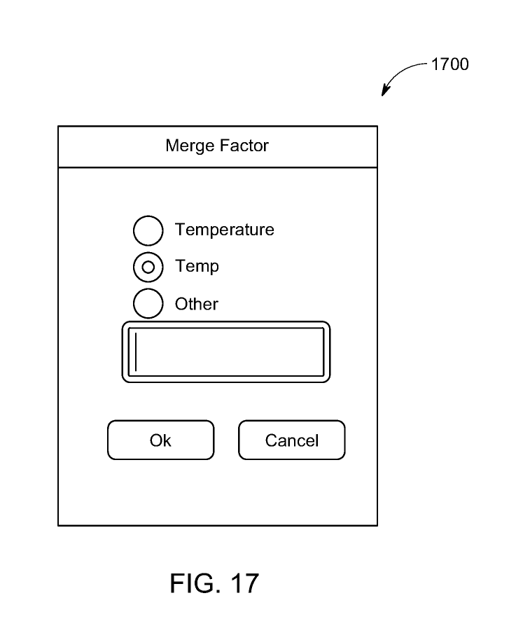

FIG. 17 depicts a graphical user interface 1700, in which the user can select from the variant names or enter a new name altogether. Clicking OK will change the corresponding name references in the system. Note that the original names are still available, and an audit trail may be maintained within the system to track these or other changes.

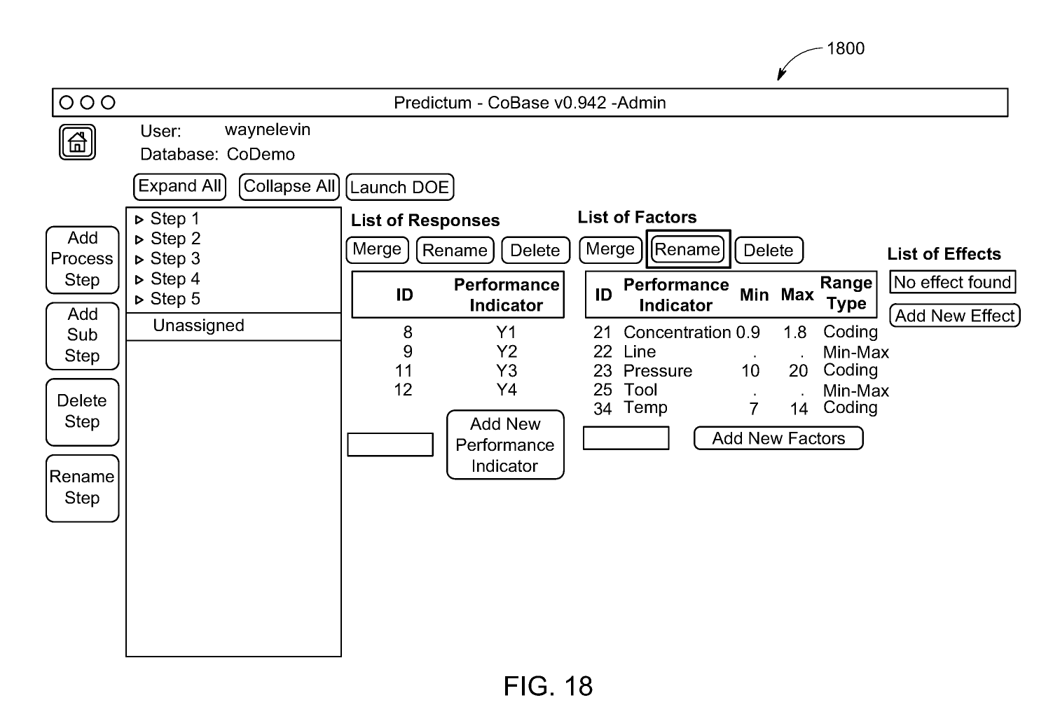

FIG. 18 depicts a graphical user interface 1800 for renaming the List of Factors and consolidating.

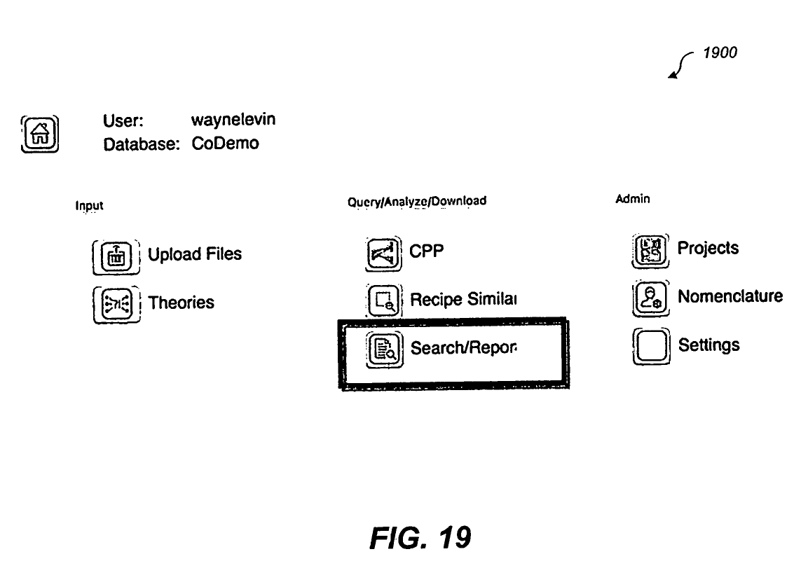

FIG. 19 depicts a graphical user interface 1900 in which various reports can be found from the reporting button. In one embodiment, a report may answer a question such as: “who else has looked at certain CTQs or certain factors at certain steps” in order to provide a starting point for further research that takes advantage of prior knowledge, including insights available from the work of others as stored in the historical pools of information in the system 10 (FIG. 2).

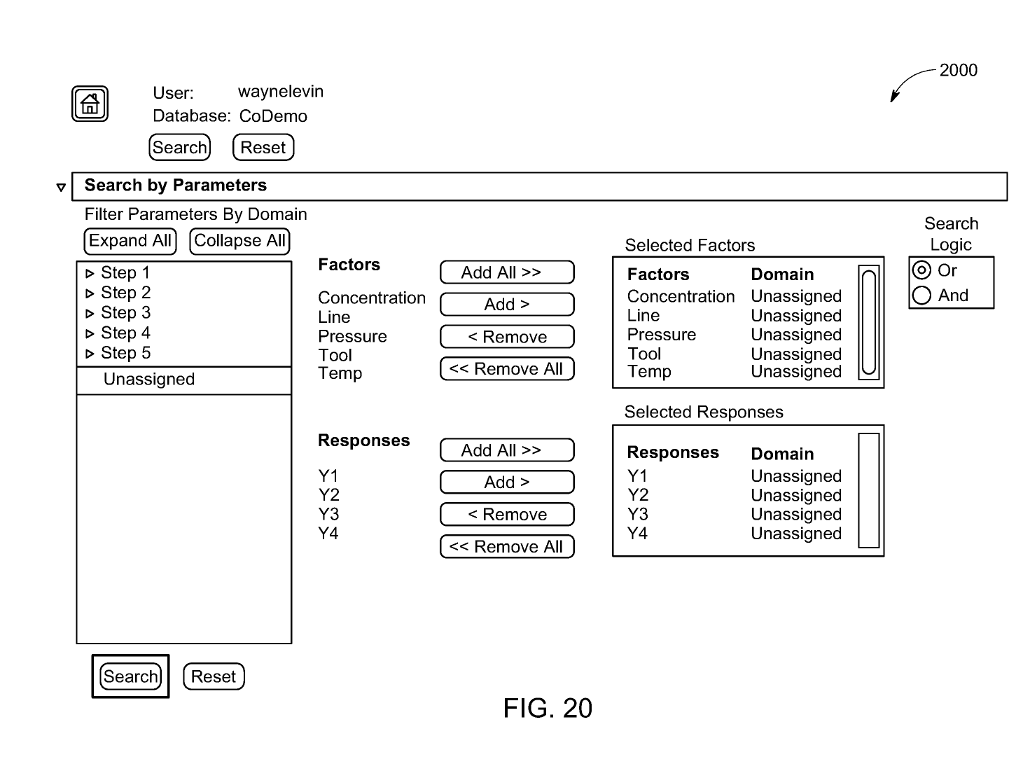

FIG. 20 depicts a graphical user interface 2000 in which analysts can select factors and responses from various production steps or product components and then click search.

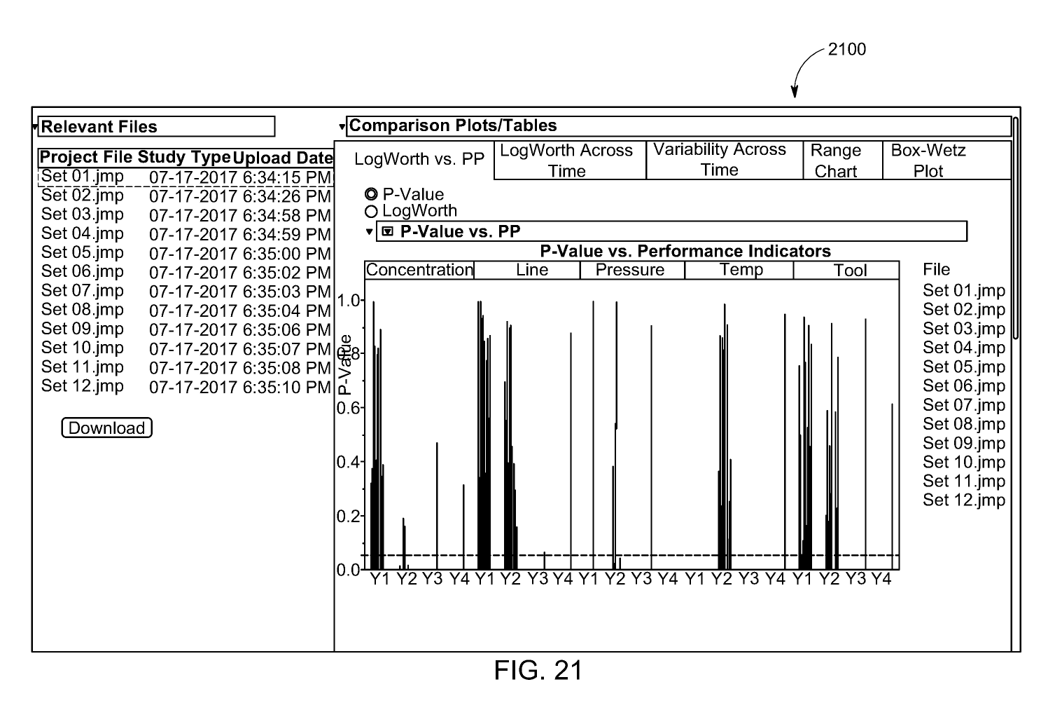

FIG. 21 depicts a graphical user interface 2100. The files associated with the selection are identified on the left and the statistical p-values from the models in these files are shown. Each vertical block represents a factor (Concentration, Line, Pressure, etc.) and on the X axis a corresponding CTQ (Y1, Y2, etc.) Those lines that are below the red dashed line indicate significant relationships at the 0.05% level.

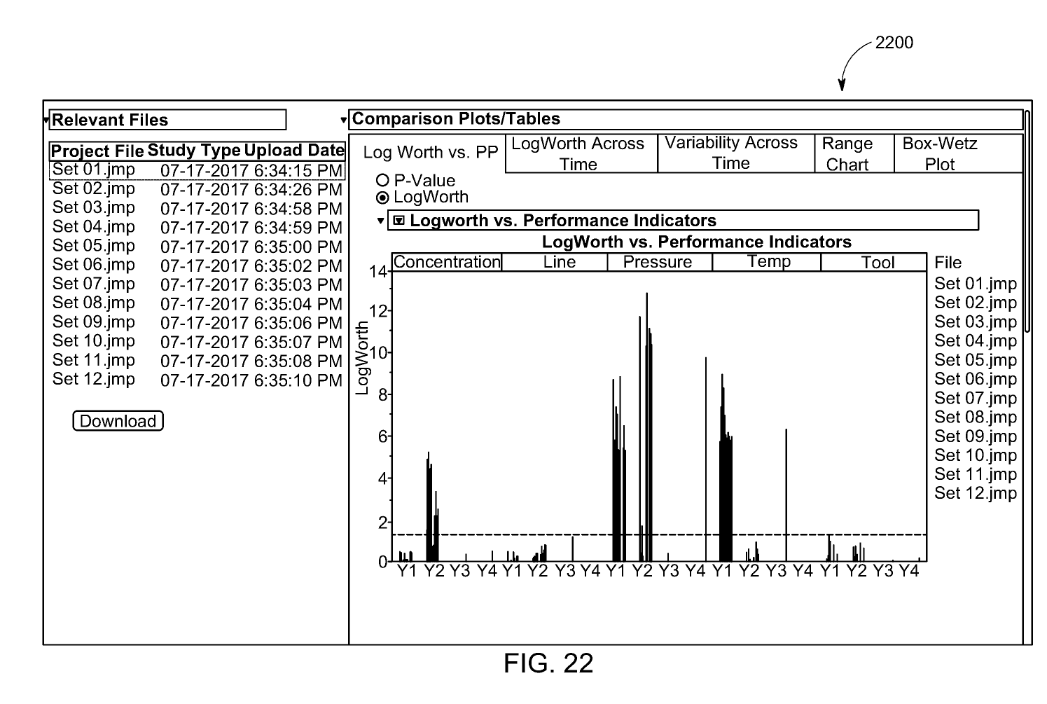

FIG. 22 depicts a graphical user interface 2200. Logworth (defined as the base-10 logarithm of the p-value) is easier to see and is a relatively new practice in statistical methods. Here, those lines above the dashed line are significant at the 5% level.

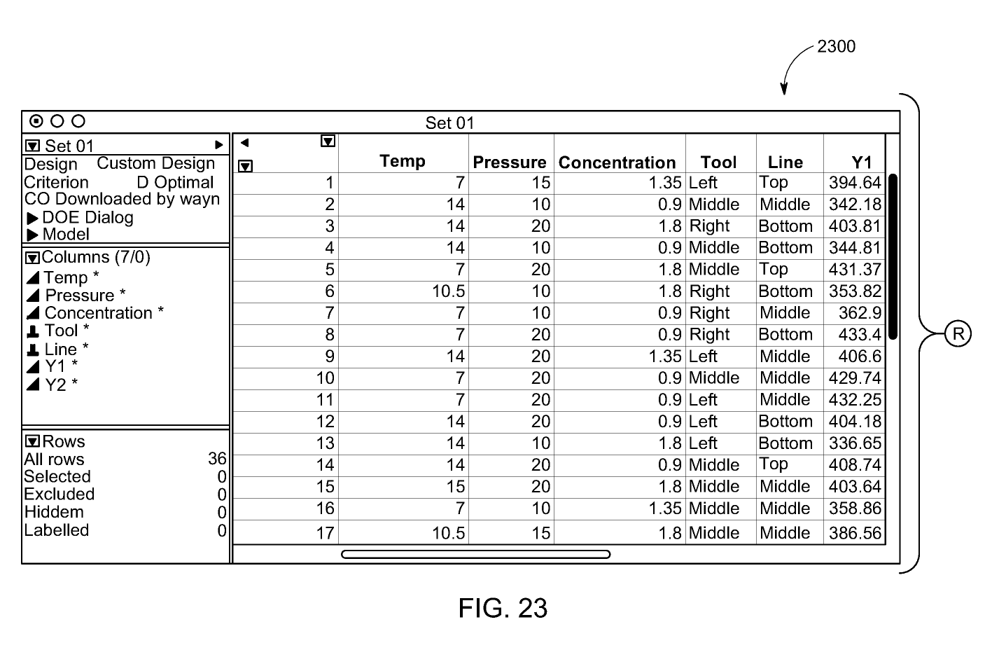

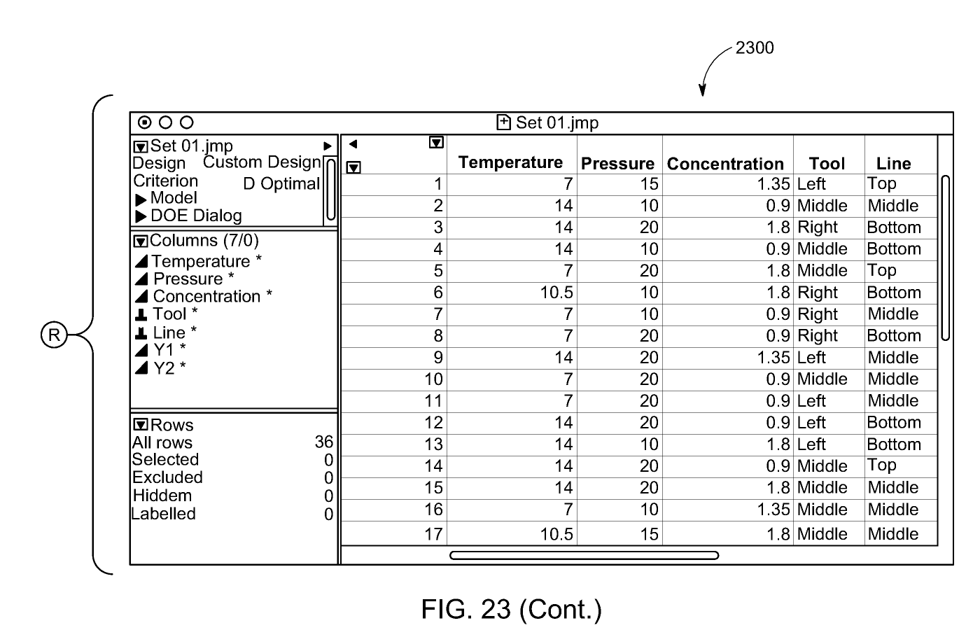

FIG. 23 depicts a graphical user interface 2300 depicting Set 01 as it was downloaded (on the left) and the original on the right. Note that now, on the left, the first column is “Temp” whereas originally it was “Temperature.” As noted in the discussion above with respect to FIG. 16, these different names for the same parameter can be combined to facilitate comparison of different datasets.

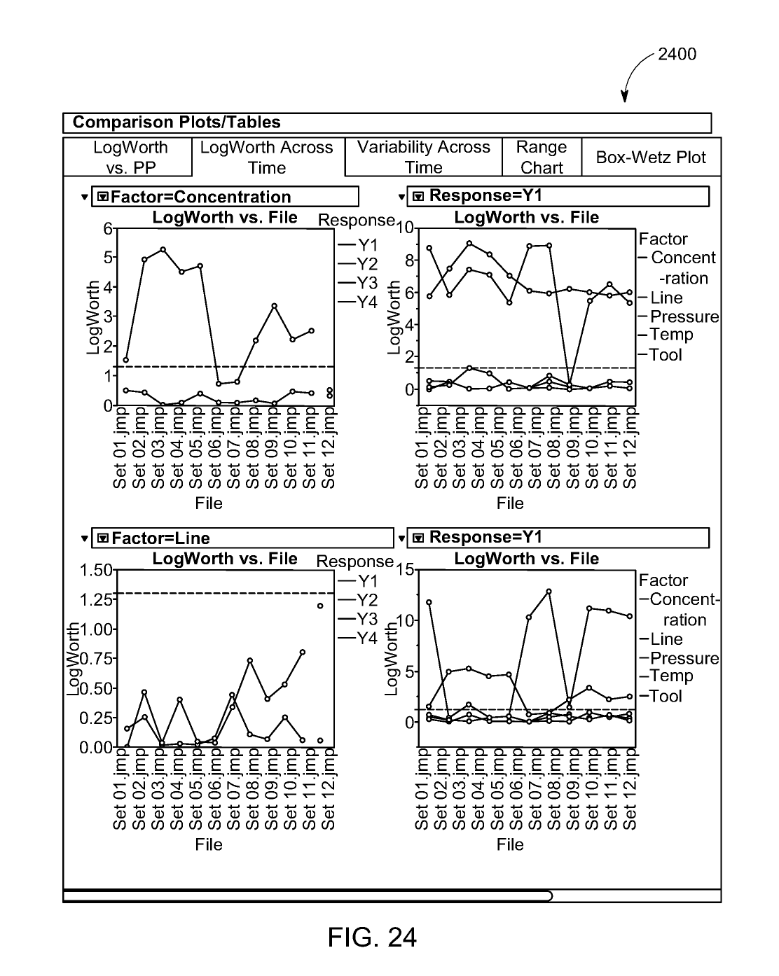

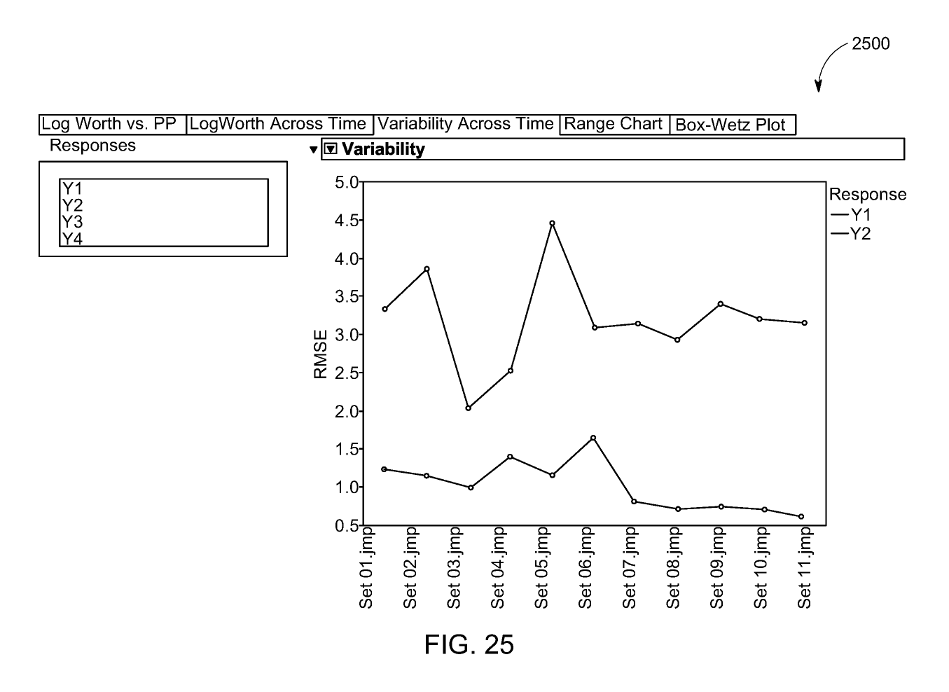

FIG. 24 depicts a graphical user interface 2400, which helps analysts understand the history of the relationships among variables. In the top-right we have a plot of logworth values. None of the experiments explained Y1's variability (blue line). Analysts can look at the factors and ranges used in these studies to know not to repeat what didn't explain Y1's variability in the past. For Y2, (red line), Set 02 through Set 05 explained a lot of variability but not Set 06 and Set 07. Here analysts can download these files, compare the factors and ranges to understand which factors explain the most. These results correspond to those show with the p-values and Log-Worth values above.

FIG. 25 depicts a graphical user interface 2500, which depicts yet another view comparing the Root Mean Square Error (RMSE) which is an indication of unexplained variation, for the responses. Y2's unexplained variation dropped noticeably beyond Set 07. This means that they have demonstrably improved their knowledge by explaining more of the operation's behavior with respect to Y2. For Y1 they are all over the map. They can examine Set 03 to see what factors and ranges lead to the most explanatory power for Y1 and use that knowledge in subsequent experimentation.

Turning again to FIGS. 1-3B, depending upon the embodiment, network 29 of FIG. 2 can include one or more of the following: a wired network, a wireless network, an LAN, an extranet, an intranet, a WAN (including, but not limited to, the Internet), a virtual private network (“VPN”), an interconnected data path across which multiple devices may communicate, a peer-to-peer network, a telephone network, portions of a telecommunications network for sending data through a variety of different communication protocols, a Bluetooth® communication network, a radio frequency (“RF”) data communication network, an infrared (“IR”) data communication network, a satellite communication network or a cellular communication network for sending and receiving data through short messaging service (“SMS”), multimedia messaging service (“MMS”), hypertext transfer protocol (“HTTP”), direct data connection, Wireless Application Protocol (“WAP”), email or any other suitable message transfer service or format.

In an embodiment, the one or more processors 22 can include a data processor or a central processing unit (“CPU”). Each such one or more data storage devices can include, but is not limited to, a hard drive with a spinning magnetic disk, a Solid-State Drive (“SSD”), a floppy disk, an optical disk (including, but not limited to, a CD or DVD), a Random Access Memory (“RAM”) device, a Read-Only Memory (“ROM”) device (including, but not limited to, programmable read-only memory (“PROM”), electrically erasable programmable read-only memory (“EPROM”), electrically erasable programmable read-only memory (“EEPROM”), a magnetic card, an optical card, a flash memory device (including, but not limited to, a USB key with non-volatile memory, any type of media suitable for storing electronic instructions or any other suitable type of computer-readable storage medium.

Referring to FIG. 2, any suitable input/output 27 may be used to transmit inputs to processors 22 and to receive outputs from processor 22, including, but not limited to, a personal computer (PC) (including, but not limited to, a desktop PC, a laptop or a tablet), smart television, Internet-enabled TV, person digital assistant, smartphone, cellular phone or mobile communication device. In one embodiment, such I/O device has at least one input device (including, but not limited to, a touchscreen, a keyboard, a microphone, a sound sensor or a speech recognition device) and at least one output device (including, but not limited to, a speaker, a display screen, a monitor or an LCD).

In an embodiment, the method 30 includes computer-readable instructions, algorithms and logic that are implemented with any suitable programming or scripting language, including, but not limited to, C, C++, Java, COBOL, assembler, PERL, Visual Basic, SQL, JMP Scripting Language, Python, Stored Procedures or Extensible Markup Language (XML). The method 30 can be implemented with any suitable combination of data structures, objects, processes, routines or other programming elements.

In an embodiment, the display 28 can include GUIs structured based on any suitable programming language. Each GUI can include, in an embodiment, multiple windows, pull-down menus, buttons, scroll bars, iconic images, wizards, the mouse symbol or pointer, and other suitable graphical elements. In an embodiment, the GUIs incorporate multimedia, including, but not limited to, sound, voice, motion video and virtual reality interfaces to generate outputs of the method 30.

In an embodiment, the memory devices and data storage devices described above can be non-transitory mediums that store or participate in providing instructions to a processor for execution. Such non-transitory mediums can take different forms, including, but not limited to, non-volatile media and volatile media. Non-volatile media can include, for example, optical or magnetic disks, flash drives, and any of the storage devices in any computer. Volatile media can include dynamic memory, such as main memory of a computer. Forms of non-transitory computer-readable media therefore include, for example, a floppy disk, flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read programming code and/or data. Many of these forms of computer readable media may be involved in carrying one or more sequences of one or more instructions to a processor for execution. In contrast with non-transitory mediums, transitory physical transmission media can include coaxial cables, copper wire and fiber optics, including the wires that comprise a bus within a computer system, a carrier wave transporting data or instructions, and cables or links transporting such a carrier wave. Carrier-wave transmission media can take the form of electric or electromagnetic signals, or acoustic or light waves such as those generated during RF and IR data communications.

In view of the foregoing, embodiments of the correlation-based design method, system and device provide: (a) enhanced process measurement and prediction techniques; (b) improvements that facilitate the design of offerings; and (c) improve the efficiency of R&D activity that continues (continuously or intermittently) for relatively long periods of time, for example, over the lifetime of an organization's product or service. A technical effect is the correlation of historical data of different operation or production process instances to produce input control factors that will allow a new production process instance to proceed with an enhanced level of measured outcome factors that are critical to the quality of the operation or production process. Another technical effect is the provision of an enhanced database system for storing, visualizing, and correlating data. Yet another technical effect is the increased speed of data processing by enabling access requests that are associated with control and outcome factors of greatest relevance to the user in contrast to having to process large data sets with intertwined relevant and irrelevant data. Still another technical effect is decreasing the usage of data storage space by enabling users to easily access historical control factors, outcome factors and scenarios without having to repeat prior R&D, thereby solving problems faster, reducing redundancies from rediscovering insights, identifying inconsistencies which may signal where to look for further improvement in knowledge, improving products and processes, and avoiding the storage of redundant data.

It should be appreciated that at least some of the subject matter disclosed herein includes or involves a plurality of steps or procedures. In an embodiment, as described, some of the steps or procedures occur automatically or autonomously as controlled by a processor or electrical controller without relying upon a human control input, and some of the steps or procedures can occur manually under the control of a human. In another embodiment, all of the steps or procedures occur automatically or autonomously as controlled by a processor or electrical controller without relying upon a human control input. In yet another embodiment, some of the steps or procedures occur semi-automatically as partially controlled by a processor or electrical controller and as partially controlled by a human.

It should also be appreciated that aspects of the disclosed subject matter may be embodied as a method, device, assembly, computer program product or system. Accordingly, aspects of the disclosed subject matter may take the form of an entirely hardware embodiment, an entirely software embodiment (including firmware, resident software, micro-code, etc.), or an embodiment combining software and hardware aspects that may all, depending upon the embodiment, generally be referred to herein as a “service,” “circuit,” “circuitry,” “module,” “assembly” and/or “system.” Furthermore, aspects of the disclosed subject matter may take the form of a computer program product embodied in one or more computer readable mediums having computer readable program code embodied thereon.

Aspects of the disclosed subject matter are described herein in terms of steps and functions with reference to flowchart illustrations and block diagrams of methods, apparatuses, systems and computer program products. It should be understood that each such step, function block of the flowchart illustrations and block diagrams, and combinations thereof, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create results and output for implementing the functions described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the functions described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions described herein.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

1. A correlation-based design method comprising:
receiving one or more access requests corresponding to a plurality of targeted outcomes of an improved version of a prior production process for an offering, wherein the offering comprises one of a product and a service;
in response to the one or more access requests:
accessing a first pool of historical control factors, wherein each of the historical control factors has been previously implemented in the prior production process;
accessing a second pool of historical outcome factors, wherein each of the historical outcome factors resulted from one of the historical control factors;
generating a first graphical correlation representation of the historical control factors, the historical outcome factors, and the targeted outcome factors, wherein the first graphical correlation representation indicates a first comparison of the historical outcome factors to the targeted outcome factors;
receiving a plurality of change requests, wherein each of the change requests is associated with a different design scenario;
in response to each of the change requests:
changing at least one of the historical control factors, and updating at least one of the historical outcome factors, wherein the at least one changed historical control factor and the at least one updated historical outcome factor comprise one of the different design scenarios;
generating a second graphical correlation representation of a plurality of the design scenarios and the targeted outcome factors, wherein the second graphical correlation representation indicates a second comparison among the updated historical outcome factors of one of the design scenarios, the updated historical outcome factors of another one of the design scenarios, and the targeted outcome factors;
receiving a selection request corresponding to a selection of one of the design scenarios; and
designating the selected design scenario for implementation in the improved version of the prior production process.

2. The method of claim 1, wherein the historical control factors are inputs to one or more production devices for implementing the prior production process.

3. The method of claim 1, wherein the historical outcome factors are outputs from one or more measurement devices for measuring the prior production process.

4. The method of claim 1, wherein the historical outcome factors comprise measured historical outcome factors and intermediate historical outcome factors, wherein the intermediate historical outcome factors are correlated to two or more of the historical outcome factors.

5. The method of claim 1, wherein the first graphical correlation representation comprises a correlation of one or more of the historical control factors to one or more steps of the prior production process.

6. The method of claim 1, wherein the first graphical correlation representation comprises a correlation of at least one historical control factor at one step of the prior production process to at least one historical outcome factor.

7. The method of claim 1, wherein the first graphical correlation representation comprises an overlay of the targeted outcome factors and the historical outcome factors.

8. The method of claim 1, wherein the second graphical correlation representation comprises a correlation of a modified range of the historical outcome factors and the historical control factors to select targeted control factors for one of the plurality of the design scenarios.

9. A correlation-based design method comprising:
receiving one or more access requests corresponding to a plurality of targeted outcomes of an improved version of a prior operation for an offering, wherein the offering comprises one of a product and a service; and
in response to the one or more access requests:
accessing a first pool of historical control factors, wherein each of the historical control factors of the first pool has been previously implemented in the prior operation;
accessing a second pool of historical outcome factors, wherein each of the historical outcome factors of the second pool resulted from one of the historical control factors; and
generating a first graphical correlation representation of the historical control factors, the historical outcome factors, and the targeted outcome factors, wherein the first graphical correlation representation indicates a first comparison of the historical outcome factors to the targeted outcome factors.

10. An offering resulting from the improved version of claim 9.

11. The method of claim 9, wherein the first graphical correlation representation comprises a correlation of at least one historical control factor at one step of the prior operation to at least one historical outcome factor.

12. The method of claim 9, further comprising receiving a plurality of change requests, wherein each of the change requests is associated with a different design scenario, and, in response to each of the change requests changing at least one of the historical control factors, and updating at least one of the historical outcome factors, wherein the at least one changed historical control factor and the at least one updated historical outcome factor comprise one of the different design scenarios.

13. The method of claim 9, further comprising generating a second graphical correlation representation of a plurality of the design scenarios and the targeted outcome factors, wherein the second graphical correlation representation indicates a second comparison among the updated historical outcome factors of one of the design scenarios, the updated historical outcome factors of another one of the design scenarios, and the targeted outcome factors.

14. The method of claim 13, wherein the second graphical correlation representation comprises a correlation of a modified range of the historical outcome factors and the historical control factors to select targeted control factors for one of the plurality of the design scenarios.

15. The method of claim 9, further comprising receiving a selection request corresponding to a selection of one of the design scenarios.

16. The method of claim 15, further comprising designating the selected design scenario for implementation in the improved version of the prior operation.

17. The method of claim 9, further comprising designating for implementation the improved version of the prior operation.

18. One or more data storage devices comprising instructions that, when executed by a processor, perform a plurality of steps comprising:
receiving one or more access requests corresponding to a plurality of targeted outcomes of an improved version of a prior operation for an offering, wherein the offering comprises one of a product and a service; and
in response to the one or more access requests:
accessing a first pool of historical control factors, wherein each of the historical control factors of the first pool has been previously implemented in the prior operation;
accessing a second pool of historical outcome factors, wherein each of the historical outcome factors of the second pool resulted from one of the historical control factors; and
generating a first graphical correlation representation of the historical control factors, the historical outcome factors, and the targeted outcome values, wherein the first graphical correlation representation indicates a first comparison of the historical outcome factors to the targeted outcome factors.

19. The one or more data storage devices of claim 18, wherein the first graphical correlation representation comprises a correlation of at least one historical control factor at one step of the prior operation to at least one historical outcome factor.

20. The one or more data storage devices of claim 18, wherein the plurality of steps further comprises:
receiving a plurality of change requests, wherein each of the change requests is associated with a different design scenario; and
generating a second graphical correlation representation of a plurality of the design scenarios and the targeted outcome factors, wherein the second graphical correlation representation indicates a second comparison among the updated historical outcome factors of one of the design scenarios, the updated historical outcome factors of another one of the design scenarios, and the targeted outcome factors, wherein the second graphical correlation representation comprises a correlation of a modified range of the historical outcome factors and the historical control factors to select targeted control factors for one of the plurality of the design scenarios.
